(19) United States
(12) Patent Application Publication
(10) Pub. No.: US 2026/0350556 A1
(43) Pub. Date: Nov. 5, 2026

(54) INFORMATION PROCESSING APPARATUS, INFORMATION MANAGEMENT PROGRAM, AND INFORMATION MANAGEMENT METHOD

(71) Applicant: Fujitsu Limited, Kawasaki-shi (JP)

(72) Inventor: Yoshitomo SAKUMA, Yokohama (JP)

(73) Assignee: Fujitsu Limited, Kawasaki-shi (JP)

(21) Appl. No.: 19/710,514

(22) Filed: Jun. 17, 2026

Related U.S. Application Data
(63) Continuation of application No. PCT/JP2024/002001, filed on Jan. 24, 2024.

(51) Int. Cl. G06Q 10/40

(52) U.S. Cl. CPC G06Q 10/40

(57) ABSTRACT

An information processing apparatus includes: a processor; and a memory coupled to the processor and the processor configured to: when a determination request for the certainty of a specific post uploaded onto the Internet is received, acquire one or more pieces of property information indicating the certainty from a first storage; generate, for each of the one or more pieces of acquired property information, first information indicating an affirmation degree of a content of the specific post by each piece of property information; generate, for each of the one or more pieces of acquired property information, second information indicating a reliability degree of a generation entity of each piece of property information; determine the certainty based on the first information and the second information for each of the one or more pieces of property information; and output a determination result of the certainty.

### CROSS-REFERENCE TO RELATED APPLICATION

This application is a continuation application of International Application Number PCT/JP2024/002001 filed on Jan. 24, 2024 and designated the U.S., the entire contents of which are incorporated herein by reference.

### FIELD

The present invention relates to an information processing apparatus, an information management program, and an information management method.

### BACKGROUND

In recent years, with the spread of smartphones and social networking services (SNSs), it is possible to transmit and read information on the Internet regardless of time and place. However, the information transmitted in this manner may include, for example, intentionally spread false or incorrect information (hereinafter, also referred to as false information), and the false information may be spread in some circumstances.

Therefore, from the viewpoint of suppressing the spread of the false information as described above, for example, various methods for confirming the certainty of posts on the Internet may be used.

Specifically, in a case where a reader of the post (hereinafter, also simply referred to as a reader) reads the post described above, for example, the reader determines whether or not a contributor is a reliable person by utilizing a method other than the Internet such as a prior contract, an individual information processing system, or the like. Then, for example, in a case where the reader determines that the contributor is a reliable person, the reader determines that the content of the post by the contributor is certain (see, for example, JP 2014-134944 A, JP 2022-021099 A, US 2019/0179956 A, and US 2013/0066730 A).

### SUMMARY

However, in a case of utilizing the method other than the Internet, the individual information processing system, or the like as described above, the reader is not able to directly determine the certainty of each post on the Internet from the content of each post, for example. Therefore, there is a case where the reader is not able to sufficiently confirm the certainty of each post, for example.

According to an aspect of the embodiments, an information processing apparatus includes: a processor; and a memory coupled to the processor and the processor configured to: when a determination request for the certainty of a specific post uploaded onto the Internet is received, acquire one or more pieces of property information indicating the certainty from a first storage; generate, for each of the one or more pieces of acquired property information, first information indicating an affirmation degree of a content of the specific post by each piece of property information; generate, for each of the one or more pieces of acquired property information, second information indicating a reliability degree of a generation entity of each piece of property information; determine the certainty based on the first information and the second information for each of the one or more pieces of property information; and output a determination result of the certainty.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating a configuration of an information processing system 10.

FIG. 2 is a diagram illustrating a hardware configuration of an information processing apparatus 1.

FIG. 3 is a diagram illustrating functions of an information processing apparatus 1 in a first embodiment.

FIGS. 4A and 4B are diagrams illustrating information stored in a storage device 3 and a storage device 4 in the first embodiment.

FIG. 5 is a flowchart illustrating an outline of an information management process in the first embodiment.

FIG. 6 is a flowchart illustrating an addition process in the first embodiment.

FIG. 7 is a diagram illustrating an addition process in a first form.

FIG. 8 is a diagram illustrating a specific example of correspondence information 132.

FIG. 9 is a diagram illustrating a specific example of property information 131.

FIG. 10 is a diagram illustrating a specific example of post identification information 133.

FIG. 11 is a diagram illustrating a specific example of graph information 134.

FIG. 12 is a diagram illustrating a specific example of the property information 131.

FIG. 13 is a diagram illustrating a specific example of the property information 131.

FIG. 14 is a diagram illustrating a specific example of the property information 131.

FIG. 15 is a diagram illustrating a specific example of the property information 131.

FIG. 16 is a diagram illustrating a specific example of the property information 131.

FIG. 17 is a flowchart illustrating a determination process in the first embodiment.

FIG. 18 is a flowchart illustrating a determination process in the first embodiment.

FIG. 19 is a flowchart illustrating a determination process in the first embodiment.

FIG. 20 is a flowchart illustrating a determination process in the first embodiment.

FIG. 21 is a flowchart illustrating a determination process in the first embodiment.

FIG. 22 is a diagram illustrating a determination process in the first form.

FIG. 23 is a diagram illustrating a determination process in the first form.

FIG. 24 is a diagram illustrating a specific example of first list information 135.

FIG. 25 is a diagram illustrating a determination process in the first form.

FIG. 26 is a diagram illustrating a specific example of second list information 136.

FIG. 27 is a diagram illustrating a determination process in the first form.

FIG. 28 is a diagram illustrating a determination process in the first form.

FIG. 29 is a diagram illustrating a determination process in the first form.

FIG. 30 is a diagram illustrating a determination process in the first form.

FIG. 31 is a diagram illustrating a specific example of output information OP.

FIG. 32 is a diagram illustrating a specific example of the output information OP.

### DESCRIPTION OF EMBODIMENTS

### Configuration of Information Processing System in First Embodiment

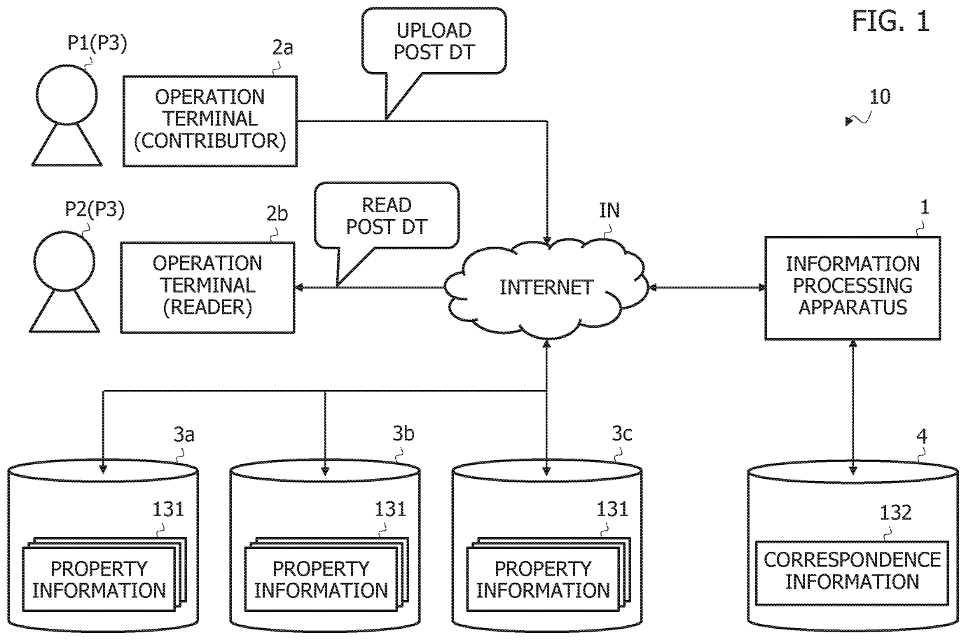

First, a configuration of an information processing system 10 will be described. FIG. 1 is a diagram illustrating the configuration of the information processing system 10.

The information processing system 10 illustrated in FIG. 1 includes, for example, an information processing apparatus 1, an operation terminal 2a, an operation terminal 2b, a storage device 3a, a storage device 3b, a storage device 3c, and a storage device 4. Hereinafter, the operation terminal 2a and the operation terminal 2b are also collectively and simply referred to as an operation terminal 2. In addition, hereinafter, the storage device 3a, the storage device 3b, and the storage device 3c are also collectively and simply referred to as a storage device 3.

The operation terminal 2 is, for example, a terminal owned by a contributor P1 or a reader P2, and is a terminal that can access a content server (not illustrated) on the Internet IN.

In the example illustrated in FIG. 1, the operation terminal 2a is, for example, a terminal owned by the contributor P1, and the contributor P1 uploads a post DT to the content server on the Internet IN. Specifically, the operation terminal 2a may be, for example, a smartphone or the like owned by the contributor P1. In addition, the operation terminal 2a can access the information processing apparatus 1 via the Internet IN, for example. Note that the post DT may be, for example, a sentence posted on the SNS.

In addition, the operation terminal 2b is, for example, a terminal owned by the reader P2, and reads the post DT uploaded by the contributor P1 to the content server on the Internet IN. Specifically, the operation terminal 2b may be, for example, a smartphone or the like owned by the reader P2. In addition, the operation terminal 2b can access the information processing apparatus 1 via the Internet IN, for example.

Note that the contributor P1 may read posts uploaded by other contributors (not illustrated) via the operation terminal 2a, for example. Further, the reader P2 may upload a post onto the Internet IN via the operation terminal 2b, for example. Further, a case where the information processing system 10 includes two operation terminals 2 (the operation terminal 2a and the operation terminal 2b) will be described below, but the information processing system 10 may include, for example, three or more operation terminals 2.

The storage device 3 is, for example, a hard disk drive (HDD) or a solid state drive (SSD), and stores property information 131 added by the contributor P1, the reader P2, or the like (hereinafter, also referred to as a generation entity P3) to the post DT on the Internet IN uploaded by the contributor P1. The generation entity P3 is, for example, a person or an object that generates the property information 131, and includes a device that automatically generates the property information 131 and a person other than the contributor P1 and the reader P2. Further, the property information 131 is, for example, information used as a determination criterion at the time of determining the certainty of the content of the post DT. Specifically, the property information 131 is, for example, information indicating a view of the generation entity P3 on the content of the post DT, information indicating an attribute such as a qualification or an affiliation organization of the contributor P1 of the post DT, or information indicating an attribute (for example, the photographing place and the photographing date and time) of image data or the like included in the post DT.

In the example illustrated in FIG. 1, each of the storage device 3a, the storage device 3b, and the storage device 3c stores, for example, property information 131 generated by each of different generation entities P3. That is, in the example illustrated in FIG. 1, each piece of property information 131 is stored in a plurality of storage devices 3 (the storage device 3a, the storage device 3b, and the storage device 3c) in a distributed manner. Note that, although a case where the information processing system 10 includes three storage devices 3 (the storage device 3a, the storage device 3b, and the storage device 3c) will be described below, the information processing system 10 may include, for example, a number of storage devices 3 other than three.

The storage device 4 stores, for example, correspondence information 132 indicating the storage device 3 in which each piece of property information 131 is stored. The correspondence information 132 is, for example, information that associates each post DT uploaded onto the Internet IN with the storage device 3 that stores information related to each post DT (for example, the property information 131 for each post DT). In addition, the correspondence information 132 is, for example, information that associates each generation entity P3 with the storage device 3 that stores information related to each generation entity P3 (for example, the property information 131 for each generation entity P3). Specifically, the correspondence information 132 may be, for example, information that associates each post DT with a uniform resource locator (URL) used at the time of accessing the property information 131 of each post DT. Further, the correspondence information 132 may be, for example, information that associates each generation entity P3 with a URL used at the time of accessing the property information 131 of each generation entity P3.

The information processing apparatus 1 is, for example, one or more physical machines or one or more virtual machines, and performs a process of managing the property information 131 for the post DT (hereinafter, also referred to as an information management process).

Specifically, the information processing apparatus 1 in the present embodiment receives, for example, the property information 131 (hereinafter, also referred to as specific property information 131) indicating the certainty of the post DT (hereinafter, also referred to as a specific post DT) uploaded onto the Internet IN, and a digital signature (hereinafter, also referred to as a specific digital signature) generated from the specific property information 131. Then, for example, the information processing apparatus 1 refers to the storage device 4 that stores the correspondence information 132 for associating each post DT with the storage device 3 that stores information related to each post DT (hereinafter, also simply referred to as the correspondence information 132), and specifies the storage device 3 (hereinafter, also referred to as a specific storage device 3) corresponding to the specific post DT from the plurality of storage devices 3. Thereafter, the information processing apparatus 1 stores, for example, the specific property information 131 to which identification information of the specific post DT and the specific digital signature are added in the specific storage device 3 (hereinafter, also referred to as a storage unit).

That is, for example, the information processing apparatus 1 in the present embodiment stores each piece of property information 131 in a state in which the digital signature generated by the generation entity P3 of each piece of property information 131 is added, thereby securing authenticity and non-falsification of each piece of property information 131. Further, the information processing apparatus 1 in the present embodiment stores, for example, each piece of property information 131 in the storage device 3 determined according to the correspondence information 132 generated in advance.

As a result, for example, in a case where the reader P2 reads the post DT uploaded onto the Internet IN, the reader P2 can appropriately determine the certainty of the post DT by referring to the property information 131 for the post DT. Further, for example, even in a case where each piece of property information 131 is stored in the plurality of storage devices 3 in a distributed manner, the reader P2 can read each piece of property information 131.

Further, for example, in a case where other property information 131 corresponding to a person or an object related to the specific post DT (hereinafter, also simply referred to as other property information 131) is already stored in the specific storage device 3, the information processing apparatus 1 in the present embodiment stores the specific property information 131 corresponding to the specific post DT and other property information 131 in association with each other.

That is, for example, when each piece of property information 131 is stored in the storage device 3, the information processing apparatus 1 in the present embodiment forms a graph structure by associating with other property information 131 for the generation entity P3 of each piece of property information 131 or other property information 131 for the object of the post DT corresponding to each piece of property information 131.

As a result, for example, even in a case where the reader P2 is not able to determine the certainty of each post DT from the content of the property information 131 for each post DT, the reader P2 can sequentially trace and confirm other property information 131 related to each post DT, and can determine the certainty of each post DT.

Specifically, for example, in a case where the reader P2 reads a post DT including a sentence “The ◯◯ river nearby the house has flooded!”, the reader P2 can also confirm the property information 131 for the post DT (for example, the property information 131 for the image data included in the post DT). Then, for example, in a case where it is determined that the place and the date and time described in the post DT are close to the place and the date and time included in the property information 131 (the photographing place and the photographing date and time of the image data included in the post DT), the reader P2 can determine that the content of the post DT is not false information, for example.

On the other hand, for example, in a case where the property information 131 including the content that the flood warning level of the ◯◯ river is low is associated with the post DT, the reader P2 can determine that there is a possibility that the content of the post DT is false information by referring to the property information 131, for example. Further, for example, as a result of tracing and referring to the property information 131 (other property information 131) for the generation entity P3 of the property information 131 indicating the flood warning level of the ◯◯ river, in a case where the generation entity P3 of the property information 131 indicating the flood warning level of the ◯◯ river is a staff member of an administrative agency (for example, an agency that manages the ◯◯ river), the reader P2 can determine that there is a high possibility that the content of the post DT is false information, for example.

Further, for example, in a case where the information processing apparatus 1 in the present embodiment receives information requesting determination on the certainty of the specific post DT (hereinafter, also referred to as determination request information), the information processing apparatus 1 refers to the storage device 4 storing the correspondence information 132, and specifies the specific storage device 3 corresponding to the specific post DT from the plurality of storage devices 3. Then, for example, the information processing apparatus 1 refers to the specific storage device 3, and acquires the specific property information 131 indicating the certainty of the specific post DT from the specific storage device 3.

Thereafter, for example, the information processing apparatus 1 generates information indicating an affirmation degree of the content of the specific post DT (hereinafter, also referred to as affirmation degree information or first information) for each piece of the acquired specific property information 131. Further, for example, the information processing apparatus 1 generates information indicating a reliability degree for the generation entity P3 (hereinafter, also referred to as reliability degree information or second information) for each piece of the acquired specific property information 131. Furthermore, for example, the information processing apparatus 1 determines the certainty of the specific post DT based on the affirmation degree information and the reliability degree information for each piece of the acquired specific property information 131. Then, the information processing apparatus 1 outputs, for example, a determination result for the certainty of the specific post DT.

That is, for example, a plurality of pieces of property information 131 indicating views of different contents may be associated with the post DT uploaded onto the Internet IN. In this case, for example, even when the reader P2 refers to each piece of property information 131 for the post DT, there is a possibility that the reader P2 is not able to determine the certainty of the post DT.

Therefore, for example, in a case where the information processing apparatus 1 in the present embodiment receives the determination request information for the certainty of the post DT, the information processing apparatus 1 determines the certainty of the post DT by using, in addition to the plurality of pieces of property information 131 associated with the post DT, the affirmation degree information indicating the affirmation degree of the content of the post DT by each piece of property information 131 and the reliability degree information indicating the reliability degree of the generation entity P3 of each piece of property information 131. Then, the information processing apparatus 1 outputs, for example, information (hereinafter, also simply referred to as output information) indicating a determination result for the certainty of the post DT.

Specifically, for example, the information processing apparatus 1 uses the affirmation degree information corresponding to each piece of property information 131 and the reliability degree information corresponding to the generation entity P3 of each piece of property information 131 to specify the property information 131 suitable for determination on the certainty of the post DT (the property information 131 that can be determined to have high reliability) among the plurality of pieces of property information 131 associated with the post DT, and uses the specified property information 131 to determine the certainty of the post DT.

As a result, for example, even in a case where a plurality of pieces of property information 131 indicating views of different contents is associated with the post DT, the reader P2 can determine the certainty of the post DT by reading the output information (output information indicating a determination result for the certainty of the post DT) output from the information processing apparatus 1 together.

Note that a case where the determination target of the certainty is the post DT will be described below, but the present invention is not limited thereto. Specifically, the information processing apparatus 1 in the present embodiment may determine the certainty of various types of information other than the post DT uploaded onto the Internet, for example.

### Hardware Configuration of Information Processing Apparatus

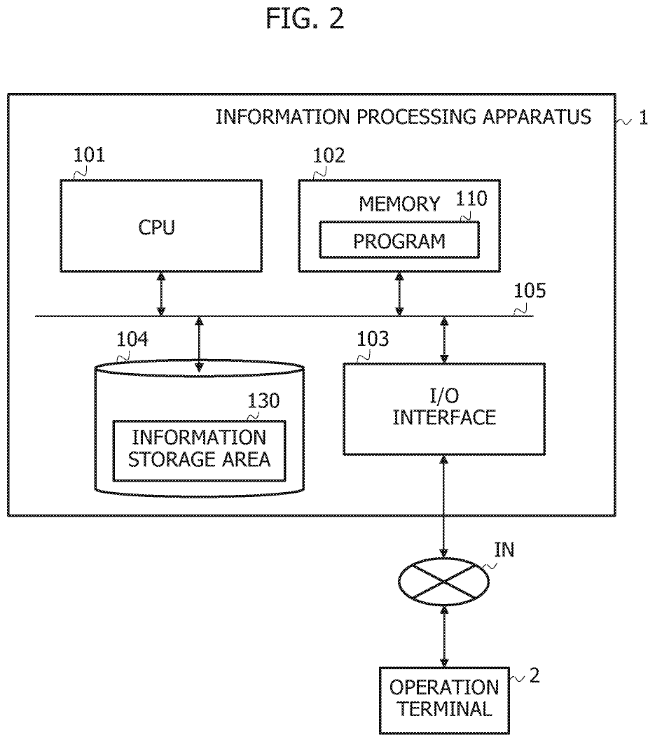

Next, a hardware configuration of the information processing apparatus 1 will be described. FIG. 2 is a diagram illustrating the hardware configuration of the information processing apparatus 1.

As illustrated in FIG. 2, the information processing apparatus 1 includes, for example, a central processing unit (CPU) 101 which is a processor, a memory 102, a communication device (I/O interface) 103, and a storage 104. The respective units are connected to one another via a bus 105.

The storage 104 has, for example, a program storage area (not illustrated) that stores a program 110 for performing the information management process. In addition, the storage 104 has, for example, an information storage area 130 that stores information used when the information management process is performed. Note that the storage 104 may be, for example, an HDD or an SSD.

For example, the CPU 101 executes the program 110 loaded from the storage 104 to the memory 102 to perform the information management process.

In addition, the communication device 103 performs communication with the operation terminal 2 and the storage device 3 via the Internet IN, for example. Note that the communication device 103 may also perform communication with the storage device 4 via the Internet IN, for example.

### Functions of Information Processing Apparatus in First Embodiment

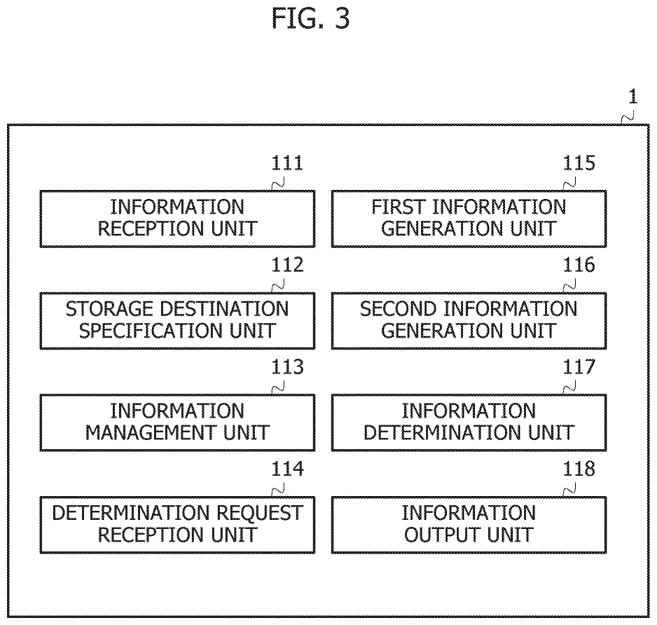

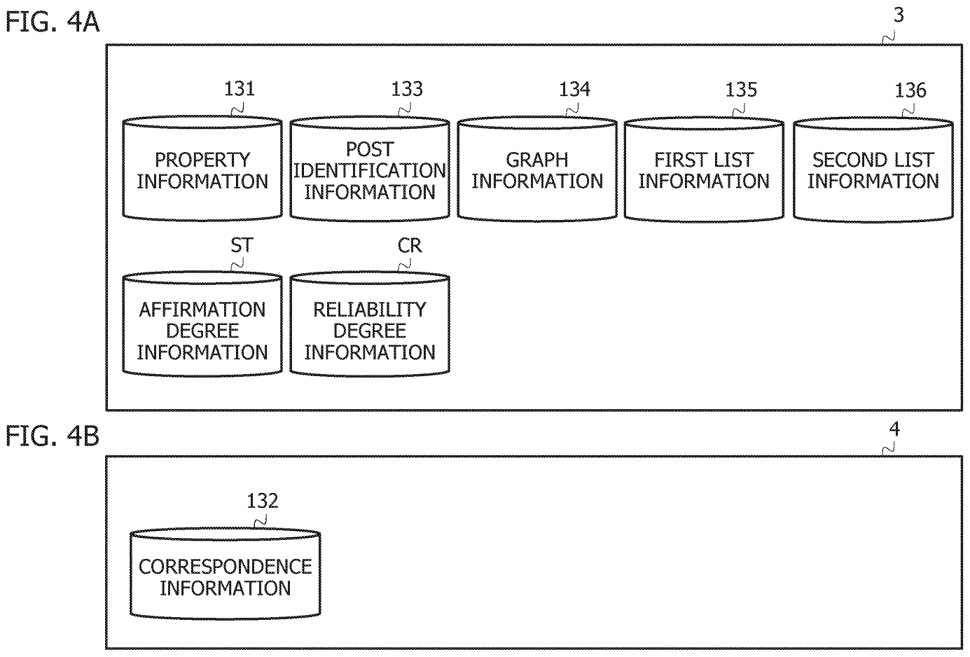

Next, functions of the information processing apparatus 1 in the first embodiment will be described. FIG. 3 is a diagram illustrating the functions of the information processing apparatus 1 in the first embodiment. FIGS. 4A and 4B are diagrams illustrating information stored in the storage device 3 and the storage device 4 in the first embodiment. Specifically, FIG. 4A is a diagram illustrating information stored in the storage device 3, and FIG. 4B is a diagram illustrating information stored in the storage device 4.

As illustrated in FIG. 3, for example, hardware such as the CPU 101 and the memory 102 and the program 110 cooperate organically, whereby the information processing apparatus 1 implements various functions including an information reception unit 111, a storage destination specification unit 112, an information management unit 113, a determination request reception unit 114, a first information generation unit 115, a second information generation unit 116, an information determination unit 117, and an information output unit 118.

Further, as illustrated in FIG. 4A, the storage device 3 stores, for example, property information 131, post identification information 133 (hereinafter, also simply referred to as identification information 133), graph information 134, list information 135 (hereinafter, also referred to as first list information 135), list information 136 (hereinafter, also referred to as second list information 136), affirmation degree information ST, and reliability degree information CR. Furthermore, as illustrated in FIG. 4B, the storage device 4 stores, for example, correspondence information 132. The graph information 134, the list information 135, and the list information 136 will be described later.

Note that a case where the property information 131, the post identification information 133, the graph information 134, the list information 135, the list information 136, the affirmation degree information ST, and the reliability degree information CR are stored in the storage device 3 will be described below, but the present invention is not limited thereto. Specifically, the list information 135, the list information 136, the affirmation degree information ST, and the reliability degree information CR may be stored in a storage device (for example, the information storage area 130 in the information processing apparatus 1) other than the storage device 3, for example.

First, a function in a process (hereinafter, also referred to as an addition process) at the time of performing storage (addition) of the property information 131 to the storage device 3 in the information management process will be described.

The information reception unit 111 receives, for example, specific property information 131 for the specific post DT uploaded onto the Internet IN and a specific digital signature generated for the specific property information 131 from the operation terminal 2. Specifically, the information reception unit 111 receives, for example, information in which specific property information 131 transmitted by the generation entity P3 such as the contributor P1 via the operation terminal 2 is associated with a specific digital signature.

For example, in a case where the information reception unit 111 receives the specific property information 131 and the specific digital signature, the storage destination specification unit 112 refers to the storage device 4 that stores the correspondence information 132, and specifies the specific storage device 3 corresponding to the specific post DT from the plurality of storage devices 3.

The information management unit 113 stores, for example, information in which the specific property information 131 received from the information reception unit 111, the specific digital signature received from the information reception unit 111, and the post identification information 133 for the specific post DT are associated with each other in the specific storage device 3 specified by the storage destination specification unit 112. The post identification information 133 is, for example, information for identifying each post DT, and is information stored in advance in the storage device 3 by the content server to which each post DT is uploaded, or information stored in the storage device 3 by the generation entity P3 of the property information 131 for each post DT.

Next, a function in a process (hereinafter, also referred to as a determination process) at the time of performing determination on the certainty of the specific post DT in the information management process will be described.

The determination request reception unit 114 receives, for example, determination request information for the certainty of the specific post DT. The determination request information is, for example, information including the post identification information 133 corresponding to the specific post DT. Specifically, the determination request reception unit 114 receives, for example, determination request information transmitted by the reader P2 of the specific post DT via the operation terminal 2.

For example, the storage destination specification unit 112 refers to the storage device 4 that stores the correspondence information 132, and specifies the storage device 3 corresponding to the post identification information 133 (the post identification information 133 of the specific post DT) included in the determination request information received by the determination request reception unit 114 as the specific storage device 3 in which the property information 131 (the specific property information 131) indicating the certainty of the specific post DT is stored.

For example, the information management unit 113 refers to the specific storage device 3 and acquires the specific property information 131 (one or more pieces of property information 131).

For example, the first information generation unit 115 generates affirmation degree information ST indicating an affirmation degree of the content of the specific post DT for each piece of the specific property information 131 acquired by the information management unit 113.

For example, the second information generation unit 116 generates the reliability degree information CR indicating a reliability degree for the generation entity P3 for each piece of the specific property information 131 acquired by the information management unit 113.

For example, the information determination unit 117 determines the certainty of the specific post DT based on the affirmation degree information ST (the affirmation degree information ST for each piece of the specific property information 131) generated by the first information generation unit 115 and the reliability degree information CR (the reliability degree information CR for each piece of the specific property information 131) generated by the second information generation unit 116.

For example, the information output unit 118 transmits output information indicating the determination result by the information determination unit 117 to the operation terminal 2 (the operation terminal 2 that has transmitted the determination request information to the information processing apparatus 1). Then, in this case, for example, the operation terminal 2 displays the output information received from the information determination unit 117 on an output device (not illustrated) of the operation terminal 2 in association with the specific post DT.

Note that a case where the addition process and the determination process are performed in the information processing apparatus 1 will be described below, but the present invention is not limited thereto. Specifically, the addition process and the determination process may be performed, for example, in a plurality of different information processing apparatuses 1, respectively.

### Outline of Information Management Process in First Embodiment

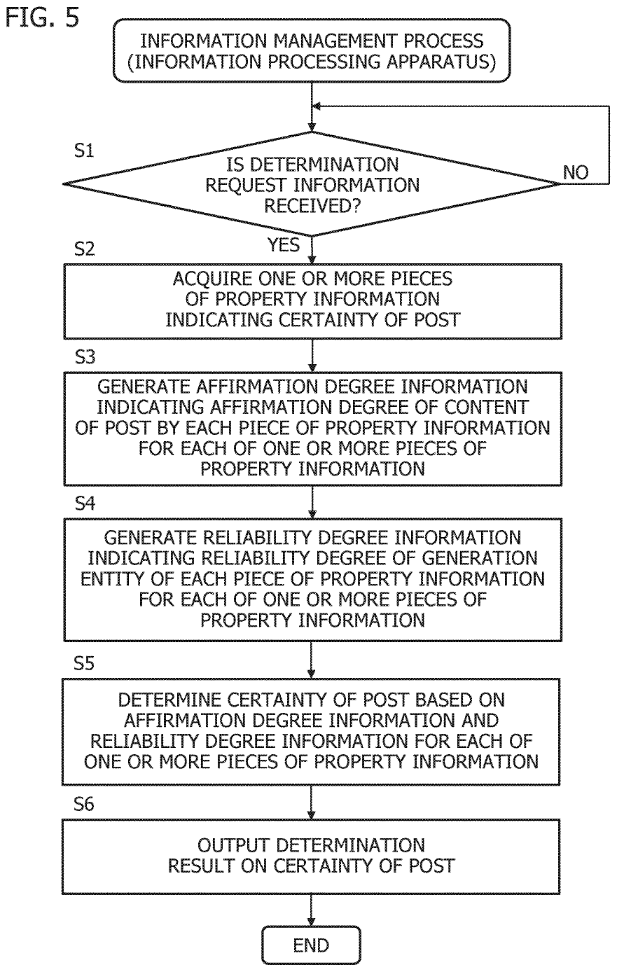

Next, an outline of the first embodiment will be described. FIG. 5 is a flowchart illustrating an outline of the information management process in the first embodiment. Specifically, FIG. 5 is a flowchart illustrating an outline of the determination process in the first embodiment.

As illustrated in FIG. 5, for example, the information processing apparatus 1 waits until determination request information requesting determination on the certainty of a specific post DT uploaded onto the Internet IN is received (NO in S1). Specifically, for example, the information processing apparatus 1 waits until the determination request information transmitted from the operation terminal 2 is received.

Then, in a case where the determination request information requesting the determination on the certainty of the specific post DT is received (YES in S1), the information processing apparatus 1 refers to, for example, the specific storage device 3 corresponding to the specific post DT, and acquires the specific property information 131 indicating the certainty of the specific post DT from the specific storage device 3 (S2).

Subsequently, for example, the information processing apparatus 1 generates affirmation degree information ST indicating an affirmation degree of the content of the specific post DT for each piece of the specific property information 131 acquired in the process of S2 (S3).

Further, for example, the information processing apparatus 1 generates reliability degree information CR indicating a reliability degree for the generation entity P3 for each piece of the specific property information 131 acquired in the process of S2 (S4).

Thereafter, for example, the information processing apparatus 1 determines the certainty of the specific post DT based on the affirmation degree information ST and the reliability degree information CR acquired in the process of S3 and the process of S4 (S5).

Then, for example, the information processing apparatus 1 transmits (outputs) output information indicating the determination result in the process of S5 to the operation terminal 2 (the operation terminal 2 that has transmitted the determination request information received in the process of S1) (S6).

As a result, for example, even in a case where a plurality of pieces of property information 131 indicating views of different contents is associated with the specific post DT, the reader P2 can determine the certainty of the specific post DT by reading the output information output from the information processing apparatus 1 together.

### Details of Information Management Process in First Embodiment

Next, details of the information management process in the first embodiment will be described. Each of the addition process and the determination process in the first embodiment will be described below.

### Addition Process in First Embodiment

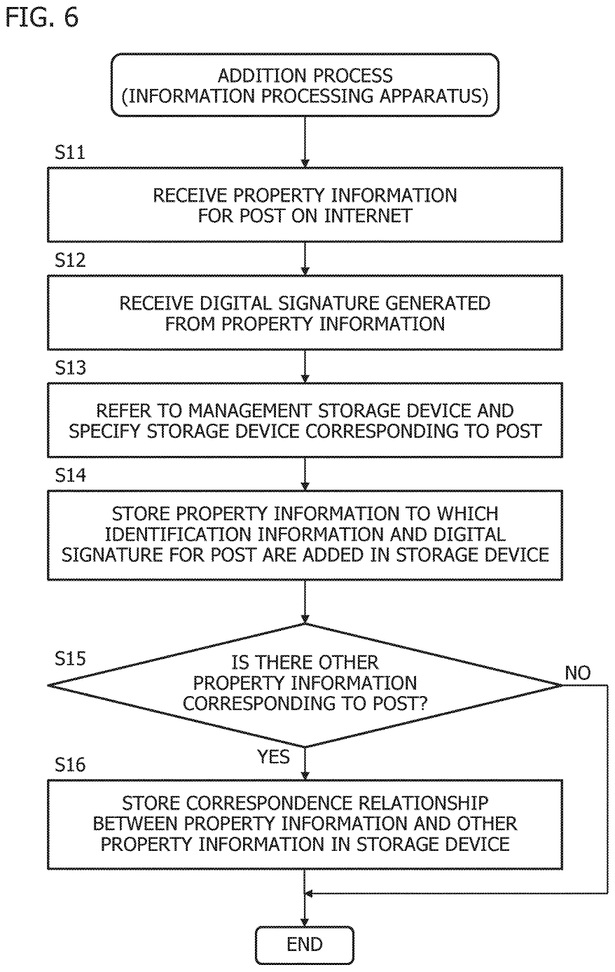

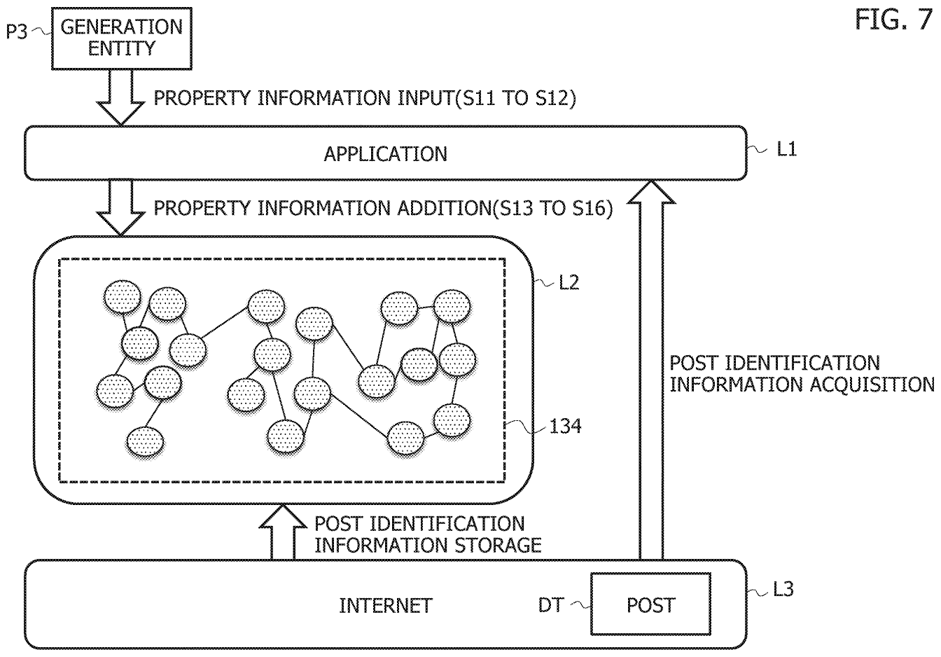

First, the addition process in the first embodiment will be described. FIG. 6 is a flowchart illustrating the addition process in the first embodiment. FIGS. 7 to 16 are diagrams illustrating the addition process in a first form.

Note that, hereinafter, as illustrated in FIG. 7 and the like, description will be made assuming that a layer in which the operation terminal 2 executes each process is an application layer L1. In the following description, it is assumed that a layer in which the information processing apparatus 1 executes each process, a layer in which the storage device 3 manages each piece of information such as the property information 131, and a layer in which the storage device 4 manages each piece of information such as the correspondence information 132 are an endorsement layer L2. Furthermore, in the following description, it is assumed that a layer in which upload, download, or the like (for example, a process by the content server) of the post DT on the Internet IN is performed is an Internet layer L3.

As illustrated in FIG. 6, the information reception unit 111 receives, for example, the property information 131 transmitted from the operation terminal 2 (S11).

Further, the information reception unit 111 receives, for example, a digital signature generated from the property information 131 in the operation terminal 2 from the operation terminal 2 (S12).

Then, the storage destination specification unit 112 refers to, for example, the storage device 4 storing the correspondence information 132 and specifies the storage device 3 associated with the post DT corresponding to the property information 131 received in the process of S11 from the plurality of storage devices 3 (S13).

Specifically, for example, the storage destination specification unit 112 specifies the storage device 3 corresponding to the post identification information 133 transmitted together with the property information 131 in the process of S11. Hereinafter, a specific example of the correspondence information 132 will be described.

### Specific Example of Correspondence Information

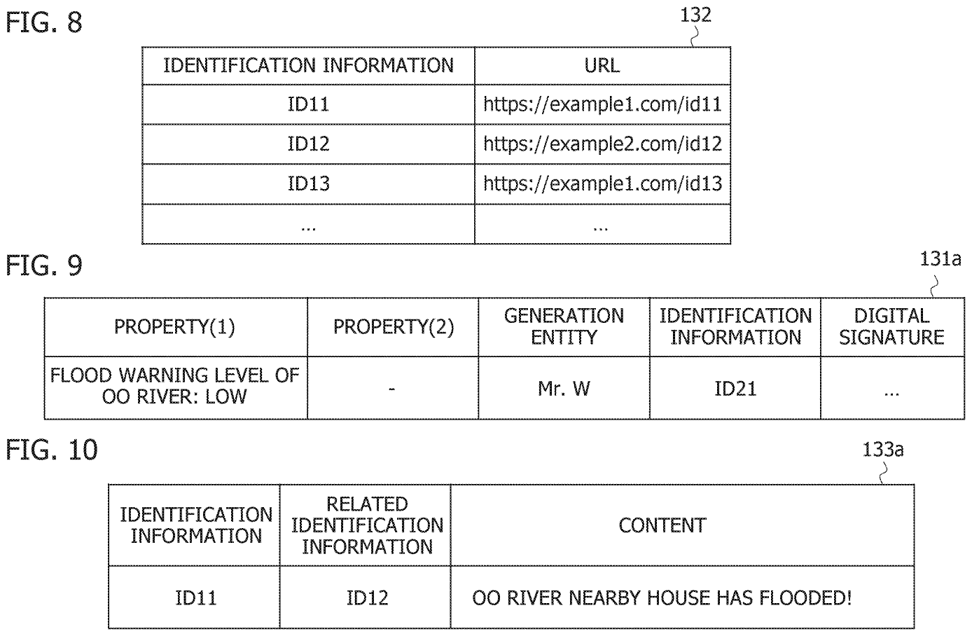

FIG. 8 is a diagram illustrating a specific example of the correspondence information 132.

The correspondence information 132 illustrated in FIG. 8 has, for example, “identification information” in which identification information (post identification information 133) of each post DT is set and “URL” in which a URL used at the time of accessing each post DT is set as items.

Specifically, in the correspondence information 132 illustrated in FIG. 8, for example, “ID11” is set as “identification information” and “https://example1.com/id11” is set as “URL” in information of a first row. That is, the information of the first row indicates, for example, that the storage destination of the property information 131 for the post DT whose “identification information” is “ID11” is the storage device 3 managed by a service corresponding to “example1.com”.

Further, in the correspondence information 132 illustrated in FIG. 8, for example, “ID12” is set as “identification information” and “https://example2.com/id12” is set as “URL” in information of a second row. That is, the information of the second row indicates, for example, that the storage destination of the property information 131 for the post DT whose “identification information” is “ID12” is the storage device 3 managed by a service corresponding to “example2.com”. Description of other information included in FIG. 8 is omitted.

Returning to FIG. 6, for example, the information management unit 113 stores information in which the post identification information 133 of the post DT corresponding to the property information 131 received in the process of S11, the digital signature received in the process of S12, and the property information 131 received in the process of S11 are associated with each other in the storage device 3 specified in the process of S13 (S14).

Specifically, for example, in a case where the post DT is uploaded by the contributor P1 on the Internet IN, the content server stores the post identification information 133 for the uploaded post DT in the storage device 3 as illustrated in FIG. 7. More specifically, in this case, for example, the content server stores the post identification information 133 in the storage device 3 in which the property information 131 for the uploaded post DT is stored.

Then, for example, in a case where the property information 131 for the post DT is generated, the generation entity P3 refers to the information included in the post DT by using the operation terminal 2, and acquires the post identification information 133 for the post DT via the operation terminal 2. Subsequently, for example, after generating the property information 131 for the post DT, the generation entity P3 generates a digital signature certifying authenticity and non-falsification of the generated property information 131. Further, the generation entity P3 transmits, for example, the property information 131 in a state in which the digital signature and the post identification information 133 for the post DT are added from the operation terminal 2 to the information processing apparatus 1. Note that the post identification information 133 for the post DT may be stored in the storage device 3 by the generation entity P3 that generates the property information 131 for the post DT, for example.

Thereafter, the information reception unit 111 receives, for example, the property information 131 (property information 131 to which the digital signature and the post identification information 133 for the post DT are added) transmitted from the operation terminal 2 (S11 and S12). Then, the storage destination specification unit 112 refers to, for example, the storage device 4 storing the correspondence information 132 and specifies the storage device 3 storing the property information 131 transmitted from the operation terminal 2 (S13). Thereafter, for example, the information management unit 113 stores the property information 131 received by the information reception unit 111 in the storage device 3 specified by the storage destination specification unit 112 (S14).

Returning to FIG. 6, for example, in the storage device 3 specified in the process of S13, the information management unit 113 determines whether or not other property information 131 corresponding to the property information 131 received in the process of S11 is stored in the storage device 3 (S15).

Specifically, for example, the information management unit 113 determines whether or not other property information 131 for the generation entity P3 of the property information 131 received in the process of S11 is stored in the storage device 3 specified in the process of S13.

As a result, in a case where it is determined that other property information 131 corresponding to the property information 131 received in the process of S11 is stored (YES in S15), the information management unit 113 stores, for example, the property information 131 received in the process of S11 and other property information 131 determined to be stored in the storage device 3 in the process of S15 in association with each other in the storage device 3 specified in the process of S13 (S16).

Specifically, as illustrated in FIG. 7, for example, the information management unit 113 associates the property information 131 received in the process of S11 with other property information 131 related to the property information 131 received in the process of S11, thereby generating graph information 134 including a graph structure of information including the property information 131.

On the other hand, in a case where it is determined that other property information 131 corresponding to the property information 131 received in the process of S11 is not stored (NO in S15), the information management unit 113 does not perform the process of S16, for example. Specific examples of the property information 131 and the post identification information 133 will be described below.

### Specific Examples of Property Information

First, specific examples of the property information 131 will be described. FIGS. 9, 12, 13, 14, 15, and 16 are diagrams illustrating the specific examples of the property information 131. Specifically, FIG. 9 is a diagram illustrating a specific example of property information 131 (hereinafter, also referred to as property information 131a) corresponding to a post DT (hereinafter, also referred to as a post DTa) including a sentence “The ◯◯ river nearby the house has flooded!”.

The property information 131 illustrated in FIG. 9 and the like has, for example, “property (1)” and “property (2)” in which a plurality of properties included in each piece of property information 131 are set as items. Further, the property information 131 illustrated in FIG. 9 and the like has, for example, “generation entity” in which a name of the generation entity P3 of each piece of property information 131 is set, “identification information” in which identification information of the generation entity P3 of each piece of property information 131 is set, and “digital signature” in which a digital signature (encrypted data generated from each piece of property information 131) for each piece of property information 131 is set as items. Note that, in the following description, it is assumed that “-” is set to an item for which information is not set. Further, a case where two properties are set in each piece of property information 131 will be described below. However, for example, three or more properties may be set in each piece of property information 131.

Specifically, in the property information 131a illustrated in FIG. 9, for example, content “flood warning level of ◯◯ river: low” is set as “property (1)”, “-” is set as “property (2)”, “Mr. W” is set as “generation entity”, and “ID21” is set as “identification information”.

### Specific Example of Post Identification Information

Next, a specific example of the post identification information 133 will be described. FIG. 10 is a diagram illustrating the specific example of the post identification information 133. Specifically, FIG. 10 is a diagram illustrating a specific example of the post identification information 133 (hereinafter, also referred to as post identification information 133a) corresponding to the post DTa.

For example, the post identification information 133a illustrated in FIG. 10 has, as items, “identification information” in which identification information of the post DTa is set, “related identification information” in which identification information (hereinafter, also referred to as related identification information) of image data (hereinafter, also referred to as an image A) included in the post DTa is set, and “content” in which the content of the post DTa is set. Note that the post identification information 133 may have no “content”, for example.

Specifically, in the post identification information 133a illustrated in FIG. 10, for example, “ID11” is set as “identification information”, “ID12” is set as “related identification information”, and a sentence “The ◯◯ river nearby the house has flooded!” is set as “content”.

Then, in the process of S14, for example, the information management unit 113 stores the property information 131a and the post identification information 133a in the storage device 3 in an associated state, thereby managing the property information 131a and the post DTa in an associated state.

As a result, for example, at the time of reading the post DTa, the reader P2 can also refer to the property information 131a for the post DTa, and can determine the certainty of the post DTa.

Specifically, the property information 131a illustrated in FIG. 9 indicates, for example, that the flood warning level of ◯◯ river is low, and has the content different from that of the post DTa including a sentence “The ◯◯ river nearby the house has flooded!”. Therefore, the reader P2 can determine that the content of the post DTa does not match the content of the property information 131a by referring to the property information 131a together with the post DTa, for example. Therefore, for example, in a case where the reader P2 determines that Mr. W who is the generation entity P3 of the property information 131a is a reliable person, the reader P2 can determine that there is a high possibility that the content of the property information 131a is correct, and can retroactively determine that there is a high possibility that the post DTa is false information.

Further, the property information 131a illustrated in FIG. 9 has, for example, identification information of the generation entity P3. Therefore, for example, in a case where the reader P2 is not able to determine whether or not Mr. W who is the generation entity P3 of the property information 131a is a reliable person, the reader P2 can further refer to the property information 131 for Mr. W based on the identification information of the generation entity P3 included in the property information 131a. Therefore, also in this case, the reader P2 can determine whether or not the post DTa is false information by referring to the property information 131 for Mr. W. Hereinafter, a specific example of the graph information 134 will be described.

### Specific Example of Graph Information

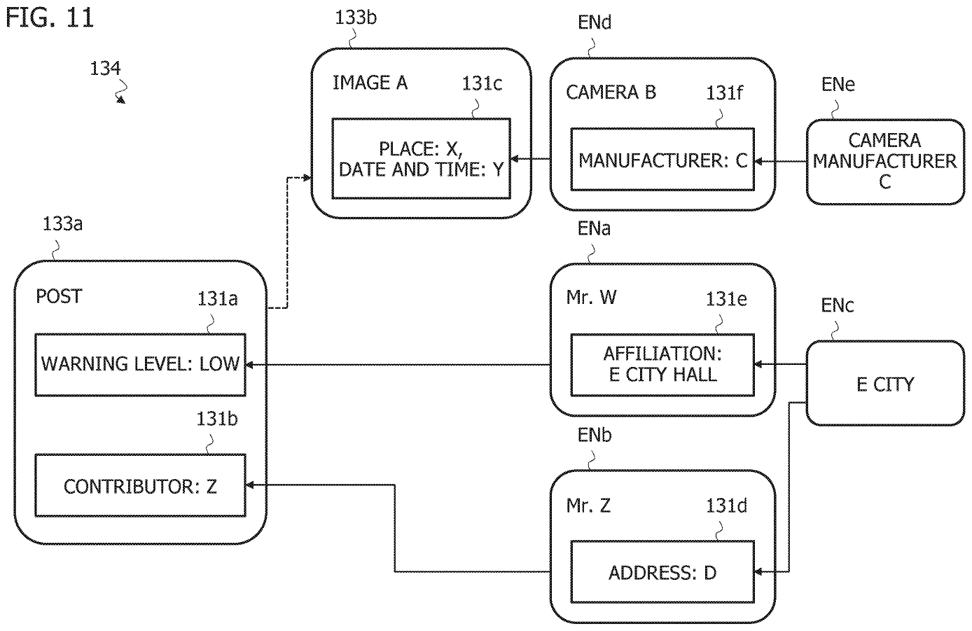

FIG. 11 is a diagram illustrating a specific example of the graph information 134. The graph information 134 is, for example, information having a graph structure including a plurality of pieces of property information 131 and a plurality of entities indicating the generation entity P3 of each of the plurality of pieces of property information 131. Hereinafter, description will be given assuming that the property information 131a in FIG. 11 corresponds to the property information 131a described in FIG. 9. Furthermore, in the following description, it is assumed that the post identification information 133a in FIG. 11 corresponds to the post identification information 133a described in FIG. 10.

In the graph information 134 illustrated in FIG. 11, for example, as the property information 131 for the post DTa (post identification information 133a), the property information 131a and the property information 131b are associated with each other. The property information 131a illustrated in FIG. 11 is associated with, for example, an entity ENa indicating that the generation entity P3 of the property information 131a is Mr. W. Further, the property information 131b illustrated in FIG. 11 is associated with, for example, an entity ENb indicating that the generation entity P3 of the property information 131b is Mr. Z.

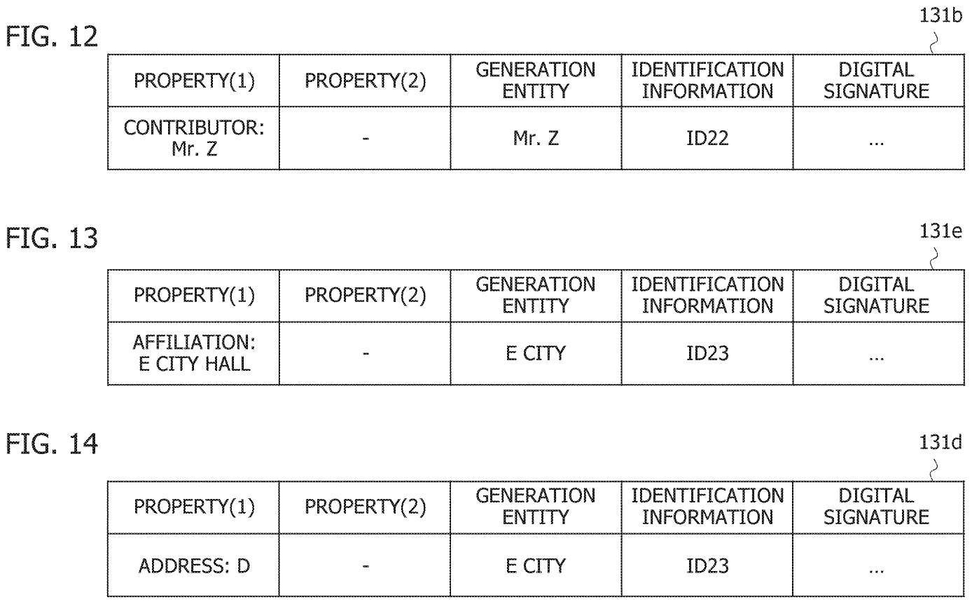

Specifically, as illustrated in FIG. 12, for example, in the property information 131b, “contributor: Mr. Z” is set as “property (1)”, “-” is set as “property (2)”, “Mr. Z” is set as “generation entity”, and “ID22” is set as “identification information”.

That is, the property information 131b illustrated in FIG. 12 is, for example, the property information 131 generated by Mr. Z who is the contributor P1 of the post DTa in order to improve reliability of the content of the post DTa.

In the graph information 134 illustrated in FIG. 11, for example, property information 131e is associated as the property information 131 for the entity ENa. In addition, the property information 131e illustrated in FIG. 11 is associated with, for example, an entity ENc indicating that the generation entity P3 of the property information 131e is E city.

Specifically, as illustrated in FIG. 13, for example, in the property information 131e, “affiliation: E city hall” is set as “property (1)”, “-” is set as “property (2)”, “E city” is set as “generation entity”, and “ID23” is set as “identification information”.

That is, the property information 131e illustrated in FIG. 13 indicates, for example, that Mr. W is a staff member of the E city hall, and is the property information 131 generated by the E city.

Then, for example, at the time of reading the post DTa, in a case where the reader P2 of the post DTa is not able to determine whether or not Mr. W is a reliable person even with reference to the property information 131a, the reader P2 further refers to the property information 131e based on the identification information of the generation entity P3 included in the property information 131a. As a result, for example, in a case where it is determined that Mr. W is a reliable person since it is guaranteed by the E city that Mr. W is a staff member of the E city hall, the reader P2 of the post DTa can retroactively determine that the content of the post DTa is highly likely to be incorrect, for example.

In the graph information 134 illustrated in FIG. 11, for example, property information 131d is associated as the property information 131 for the entity ENb. In addition, the property information 131d illustrated in FIG. 11 is associated with, for example, the entity ENc indicating that the generation entity P3 of the property information 131d is E city.

Specifically, as illustrated in FIG. 14, for example, in the property information 131d, “address: D” is set as “property (1)”, “-” is set as “property (2)”, “E city” is set as “generation entity”, and “ID23” is set as “identification information”.

That is, the property information 131d illustrated in FIG. 14 indicates, for example, that Mr. Z is a resident of D, and is the property information 131 generated by E city.

Then, for example, at the time of reading the post DTa, in a case where the reader P2 of the post DTa is not able to determine whether or not Mr. Z is a reliable person even with reference to the property information 131b, the reader P2 further refers to the property information 131d based on the identification information of the generation entity P3 included in the property information 131b. As a result, for example, in a case where it is determined that Mr. Z is a reliable person, the reader P2 of the post DTa retroactively determines that the content of the post DTa is highly likely to be correct, for example.

Further, in the graph information 134 illustrated in FIG. 11, for example, property information 131c is associated as the property information 131 for the image data (post identification information 133b) included in the post DTa. In addition, the property information 131c illustrated in FIG. 11 is associated with, for example, an entity ENd indicating that the generation entity P3 of the property information 131c is a camera B.

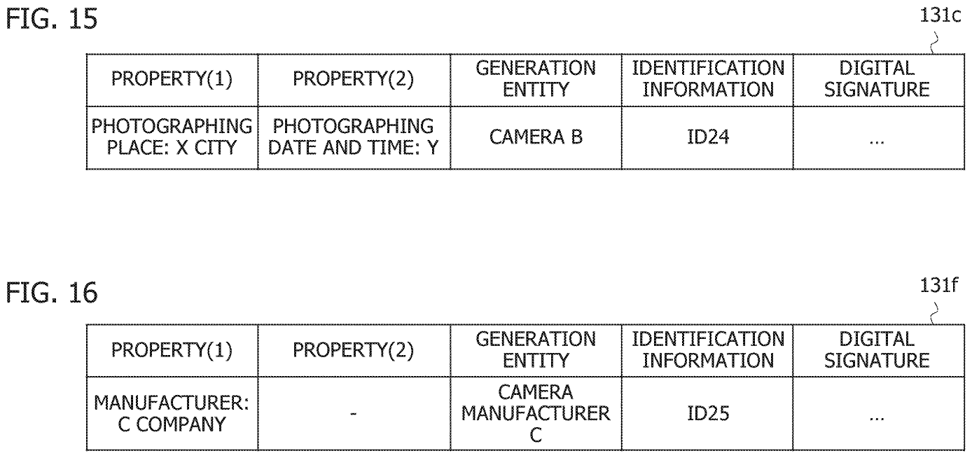

Specifically, as illustrated in FIG. 15, for example, in the property information 131c, “photographing place: X city” is set as “property (1)”, “photographing date and time: Y” is set as “property (2)”, “camera B” is set as “generation entity”, and “ID24” is set as “identification information”.

That is, the property information 131c illustrated in FIG. 15 indicates, for example, that the image data included in the post DTa is image data captured when the date and time is Y in X city, and is the property information 131 generated by the camera B.

In the graph information 134 illustrated in FIG. 11, for example, property information 131f is associated as the property information 131 for the entity ENd. In addition, the property information 131f illustrated in FIG. 11 is associated with, for example, an entity ENe indicating that the generation entity P3 of the property information 131f is a camera manufacturer C.

Specifically, as illustrated in FIG. 16, for example, in the property information 131f, “manufacturer: C company” is set as “property (1)”, “-” is set as “property (2)”, “camera manufacturer C” is set as “generation entity”, and “ID25” is set as “identification information”.

Then, for example, at the time of reading the post DTa, in a case where the reader P2 of the post DTa is not able to determine whether or not the camera B is a reliable device even with reference to the property information 131c (for example, in a case where the reader P2 is not able to determine whether or not the camera is a device capable of falsifying the capturing place of the image data included in the post DTa), the reader P2 further refers to the property information 131f specified from the identification information of the generation entity P3 included in the property information 131c. As a result, for example, in a case where it is determined that the camera B is a reliable device since the function of the camera B is guaranteed by the camera manufacturer C, the reader P2 of the post DTa retroactively determines that the content of the post DTa is highly likely to be correct, for example.

As described above, the information processing apparatus 1 in the present embodiment accumulates the information in the storage device 3 in the form of a graph structure that can be referred to by tracing the respective pieces of property information 131 related to each other, for example, when the reader P2 of the post DT confirms the certainty of the post DT.

As a result, the information processing apparatus 1 in the present embodiment can confirm the certainty of each post DT by sequentially referring to each piece of the property information 131 related to each post DT, for example, at the time of reading each post DT.

### Determination Process in First Embodiment

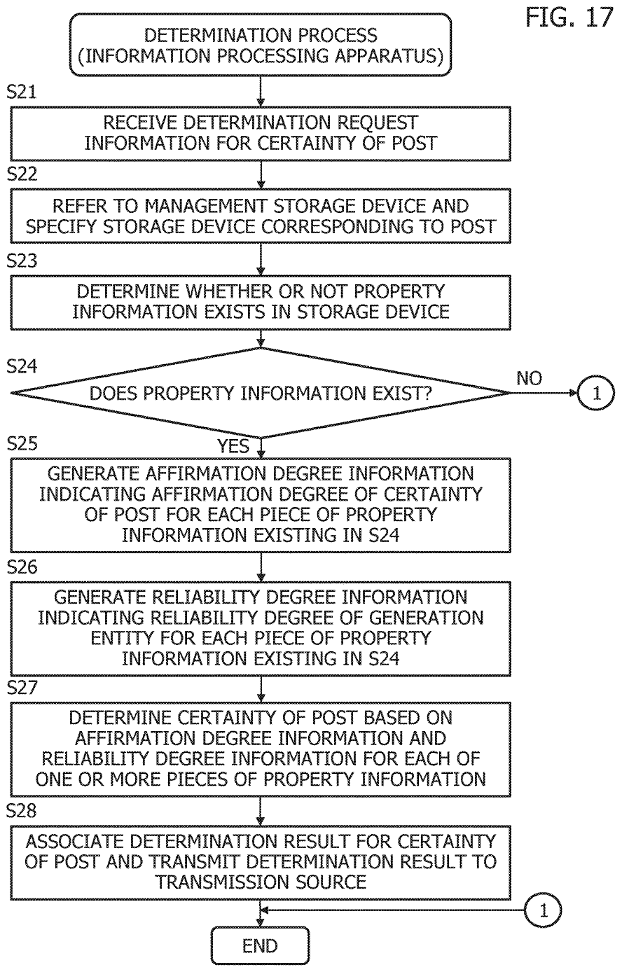

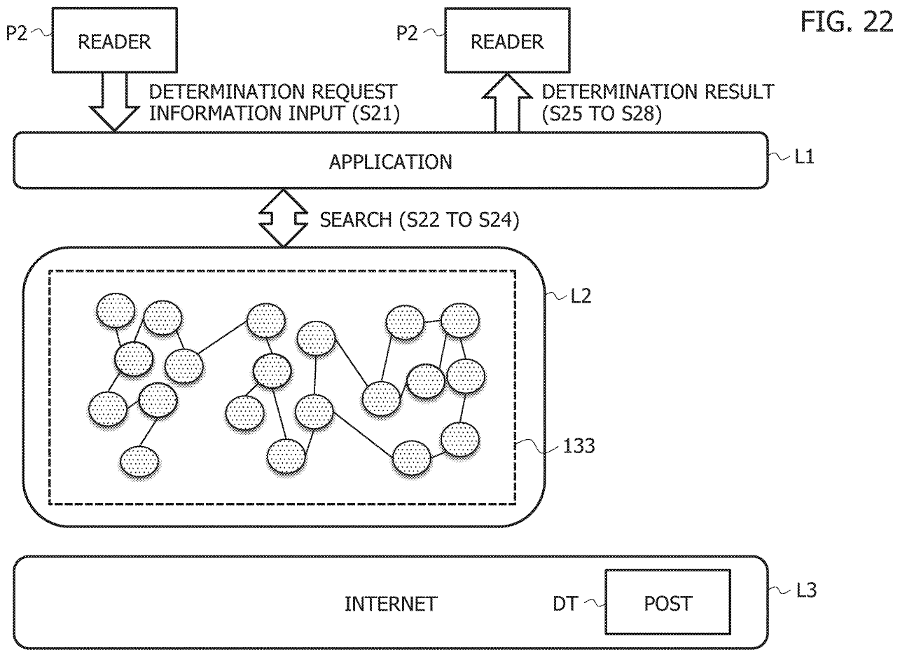

Next, a determination process in the first embodiment will be described. FIGS. 17 to 21 are flowcharts illustrating a determination process in the first embodiment. FIGS. 22 to 32 are diagrams illustrating a determination process in the first form.

As illustrated in FIG. 17, the determination request reception unit 114 receives, for example, determination request information for a post DT transmitted from the operation terminal 2 (S21).

Specifically, as illustrated in FIG. 22, for example, in a case where the reader P2 is not able to determine whether or not the content of the post DT is certain, the reader P2 inputs determination request information for the post DT from the operation terminal 2 to the information processing apparatus 1. Then, the determination request reception unit 114 receives, for example, the determination request information input by the reader P2 to the operation terminal 2.

Subsequently, the storage destination specification unit 112 refers to, for example, the storage device 4 storing the correspondence information 132 and specifies the storage device 3 corresponding to the determination request information received in the process of S21 (S22).

Specifically, for example, the storage destination specification unit 112 specifies the storage device 3 corresponding to the post identification information 133 included in the determination request information received in the process of S21.

Thereafter, for example, the information management unit 113 accesses the storage device 3 specified in the process of S22, and determines whether or not the property information 131 corresponding to the determination request information received in the process of S21 is stored, in other words, whether or not the property information 131 corresponding to the determination request information received in the process of S21 exists (S23).

Specifically, as illustrated in FIG. 22, for example, the information management unit 113 searches the property information 131 corresponding to the post identification information 133 included in the determination request information from each piece of property information 131 constituting the graph information 134 stored in the storage device 3 specified in the process of S22.

As a result, for example, in a case where it is determined that the property information 131 corresponding to the determination request information received in the process of S21 exists (YES in S24), the first information generation unit 115 generates affirmation degree information ST indicating a degree to which each piece of property information 131 affirms the content of the post DT with respect to the determination request information received in the process of S21 for each piece of property information 131 determined to exist (S25). Hereinafter, details of the process of S25 will be described.

### Details of Process of S25

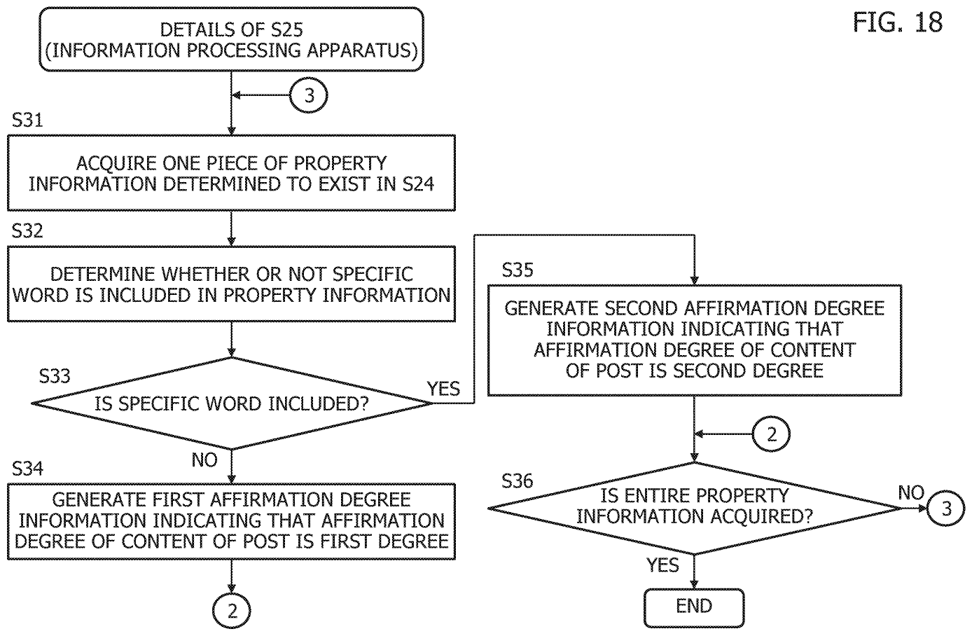

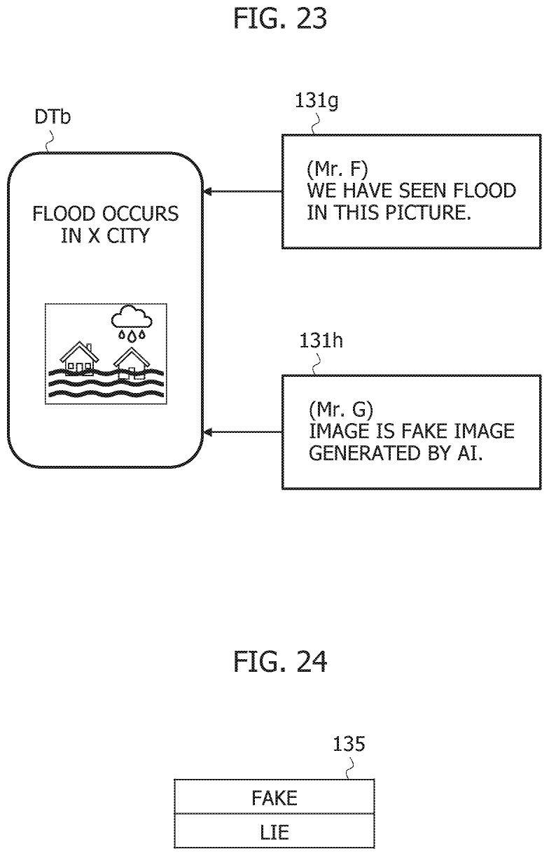

FIG. 18 is a flowchart illustrating details of the process of S25. Hereinafter, as illustrated in FIG. 23, description will be made assuming that property information 131g including a property including a sentence “We have seen the flood in this picture.” in which the generation entity P3 is “Mr. F” and property information 131h including a property including a sentence “The image is a fake image generated by AI.” in which the generation entity P3 is “Mr. G” exist as the property information 131 for the post DT (hereinafter, also referred to as a post DTb) including a sentence “The flood occurs in X city”.

As illustrated in FIG. 18, the first information generation unit 115 acquires, for example, one piece of property information 131 determined to exist in the process of S24 (S31).

Then, for example, the first information generation unit 115 refers to the first list information 135 and determines whether or not at least one of words (hereinafter, also referred to as specific words) included in the first list information 135 is included in the property information 131 acquired in the process of S31 (S32). The first list information 135 is, for example, a list of one or more words that can be determined to be highly likely to be used in the property information 131 that denies the content of the post DT.

Note that the first list information 135 may be, for example, a list of words (specific words) designated by the reader P2 who is the transmission source of the determination request information received in the process of S21. That is, the first list information 135 may be, for example, a list different for each reader P2. Hereinafter, a specific example of the first list information 135 will be described.

### Specific Example of First List Information

FIG. 24 is a diagram illustrating a specific example of the first list information 135.

The first list information 135 illustrated in FIG. 24 includes, for example, words such as “fake” and “lie” as specific words. That is, the first list information 135 illustrated in FIG. 24 includes, for example, “fake” and “lie” which are words that can be determined to be highly likely to be used in the property information 131 that denies the content of the post DT.

Returning to FIG. 18, for example, in a case where it is determined that the specific word included in the first list information 135 is not included in the property information 131 acquired in the process of S31 (NO in S33), the first information generation unit 115 generates affirmation degree information ST (hereinafter, also referred to as first affirmation degree information STa) indicating that the affirmation degree of the content of the post DT with respect to the determination request information received in the process of S21 is a first degree (S34).

On the other hand, in a case where it is determined that the specific word included in the first list information 135 is included in the property information 131 acquired in the process of S31 (YES in S33), the first information generation unit 115 generates affirmation degree information ST (hereinafter, also referred to as second affirmation degree information STb) indicating that the affirmation degree of the content of the post DT with respect to the determination request information received in the process of S21 is a second degree (S35). The second degree is, for example, a degree lower than the first degree. That is, the second affirmation degree information STb is, for example, information indicating that the content of the post DT with respect to the determination request information received in the process of S21 is more negative as compared with the first affirmation degree information STa.

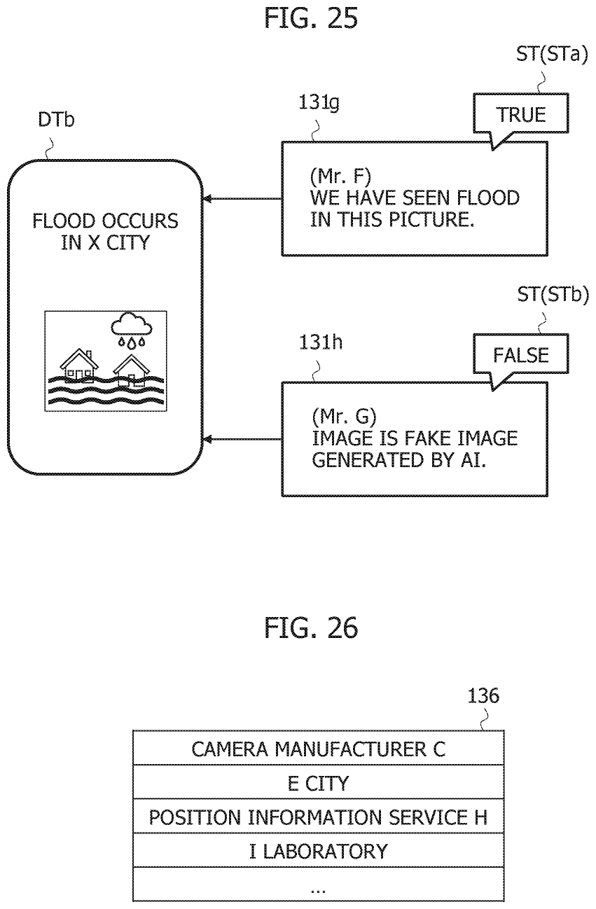

Specifically, in the example illustrated in FIG. 23, the property information 131g does not include, for example, the specific word included in the first list information 135 illustrated in FIG. 24. Therefore, as illustrated in FIG. 25, for example, the first information generation unit 115 generates “TRUE” indicating the first affirmation degree information STa as the affirmation degree information ST corresponding to the property information 131g. That is, in this case, for example, the first information generation unit 115 generates the first affirmation degree information STa indicating that the property information 131g affirms the content of the post DTb as the affirmation degree information ST corresponding to the property information 131g.

Further, in the example illustrated in FIG. 23, the property information 131h includes, for example, “fake” which is a specific word included in the first list information 135 illustrated in FIG. 24. Therefore, as illustrated in FIG. 25, for example, the first information generation unit 115 generates “FALSE” indicating the second affirmation degree information STb as the affirmation degree information ST corresponding to the property information 131h. That is, in this case, for example, the first information generation unit 115 generates the second affirmation degree information STb indicating that the property information 131h denies the content of the post DTb as the affirmation degree information ST corresponding to the property information 131h.

Note that the first list information 135 may include, for example, a specific word (hereinafter, also referred to as a first word) that can be determined to be highly likely to be used in the property information 131 that denies the content of the post DT, and a specific word (hereinafter, also referred to as a second word) that can be determined to be more likely to be used in the property information 131 that denies the content of the post DT than the first word.

Then, for example, the first information generation unit 115 may generate the affirmation degree information ST (second affirmation degree information STb) corresponding to the second degree as the affirmation degree information ST corresponding to the property information 131 including the first word, and generate another affirmation degree information ST corresponding to another degree lower than the second degree as the affirmation degree information ST corresponding to the property information 131 including the second word.

Further, for example, the first information generation unit 115 may generate the affirmation degree information ST (second affirmation degree information STb) corresponding to the second degree as the affirmation degree information ST corresponding to the property information 131 including the second word, and generate another affirmation degree information ST corresponding to another degree higher than the second degree and lower than the first degree as the affirmation degree information ST corresponding to the property information 131 including the first word.

After the process of S34 or the process of S35, for example, the first information generation unit 115 determines whether or not the entire property information 131 determined to exist in the process of S24 has been acquired (S36).

As a result, in a case where it is determined that the entire property information 131 determined to exist in the process of S24 has not been acquired (NO of S36), the first information generation unit 115 performs the processes of S31 and subsequent steps again, for example.

On the other hand, in a case where it is determined that the entire property information 131 determined to exist in the process of has been acquired (YES in S36), the first information generation unit 115 ends the process of S25, for example.

Note that, in the process of S25, the first information generation unit 115 may acquire the affirmation degree information ST by using, for example, a learned learning model (not illustrated). The learning model is, for example, a Large Language Model (LLM).

Specifically, for example, the first information generation unit 115 may input each piece of property information 131 and the post DT for the determination request information received in the process of S21 to the learning model for each piece of property information 131 determined to exist in the process of S24. Then, for example, the first information generation unit 115 may acquire the affirmation degree information ST indicated by a value output from the learning model as the affirmation degree information ST corresponding to each piece of property information 131 for each piece of property information 131 determined to exist in the process of S24.

Returning to FIG. 17, for example, the second information generation unit 116 generates the reliability degree information CR indicating the reliability degree of the generation entity P3 by each piece of property information 131 for each piece of property information 131 determined to exist in the process of S24 (S26). Hereinafter, details of the process of S26 will be described.

### Details of Process in S26

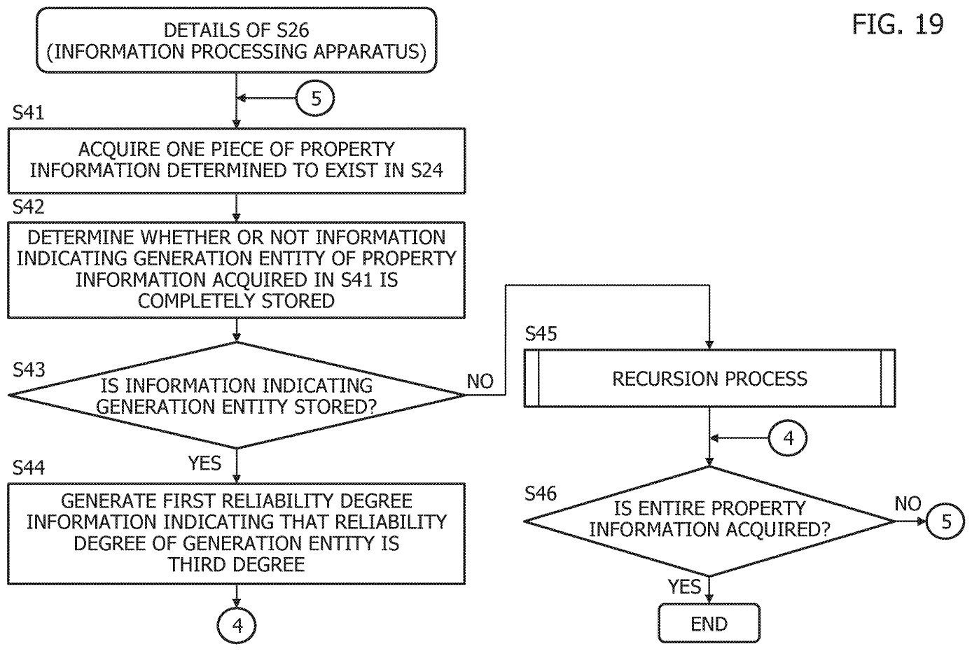

FIG. 19 is a flowchart illustrating details of the process of S26.

As illustrated in FIG. 19, the second information generation unit 116 acquires, for example, one piece of property information 131 determined to exist in the process of S24 (S41).

Then, for example, the second information generation unit 116 refers to the second list information 136 and determines whether or not information indicating the generation entity P3 of the property information 131 acquired in the process of S41 is included in the second list information 136 (S42). The second list information 136 is, for example, a list of the generation entity P3 that can be determined to be highly reliable as the generation entity P3 of the property information 131.

Note that the second list information 136 may be, for example, a list of the generation entity P3 designated by the reader P2 who is the transmission source of the determination request information received in the process of S21. That is, the second list information 136 may be, for example, a list different for each reader P2. Hereinafter, a specific example of the second list information 136 will be described.

### Specific Example of Second List Information

FIG. 26 is a diagram illustrating a specific example of the second list information 136.

The second list information 136 illustrated in FIG. 26 includes, for example, information indicating the generation entity P3 such as “camera manufacturer C”, “E city”, “position information service H”, or “I laboratory”. That is, the second list information 136 illustrated in FIG. 26 includes, for example, information indicating “camera manufacturer C” or the like, which is the generation entity P3 that can be determined to be highly reliable as the generation entity P3 of the property information 131.

Returning to FIG. 19, for example, in a case where it is determined that the information indicating the generation entity P3 of the property information 131 acquired in the process of S41 is included in the second list information 136 (YES in S43), the second information generation unit 116 generates reliability degree information CR (hereinafter, also referred to as first reliability degree information CRa) indicating that the reliability degree of the generation entity P3 of the property information 131 acquired in S41 is a third degree (S44).

On the other hand, in a case where it is determined that the information indicating the generation entity P3 of the property information 131 acquired in the process of S41 is not included in the second list information 136 (NO in S43), the second information generation unit 116 performs a recursion process on the generation of the reliability degree information CR (hereinafter, also simply referred to as a recursion process).

Specifically, in the example illustrated in FIG. 23, information indicating “Mr. F” who is the generation entity P3 of the property information 131g is not included in the list information 136 illustrated in FIG. 26, for example. Therefore, for example, in a case where the property information 131 acquired in the process of S41 is the property information 131g, the second information generation unit 116 performs the recursion process on the property information 131g.

Further, in the example illustrated in FIG. 23, information indicating “Mr. G” who is the generation entity P3 of the property information 131h is not included in the list information 136 illustrated in FIG. 26, for example. Therefore, for example, in a case where the property information 131 acquired in the process of S41 is the property information 131h, the second information generation unit 116 performs the recursion process on the property information 131h. Hereinafter, the recursion process will be described.

### Recursion Process

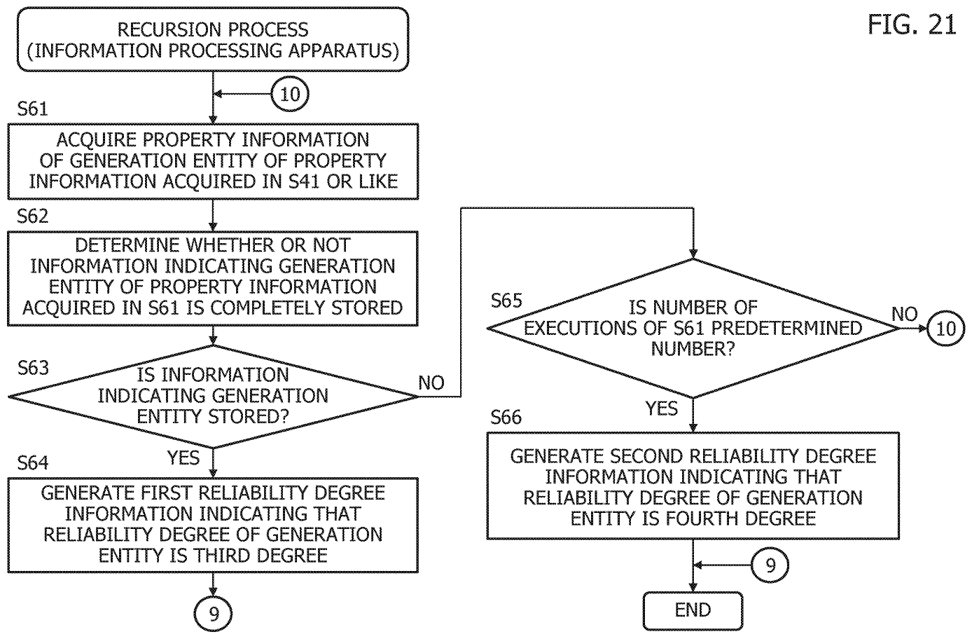

FIG. 21 is a flowchart illustrating the recursion process.

As illustrated in FIG. 21, for example, the second information generation unit 116 acquires the property information 131 for the generation entity P3 of the property information 131 acquired in the process of S41 or the like (S61).

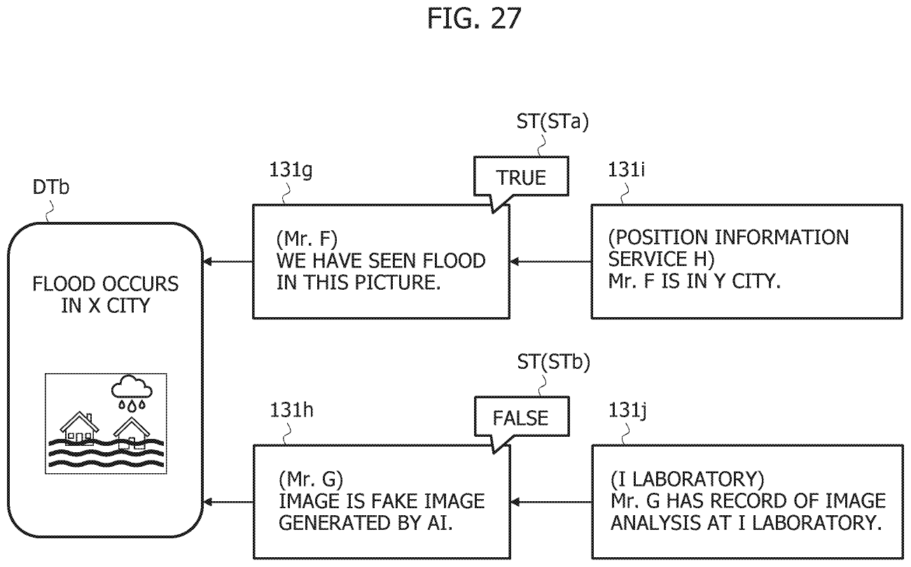

Specifically, for example, in a case where the property information 131 acquired in the process of S41 or the like is the property information 131g, the second information generation unit 116 acquires property information 131i which is the property information 131 for the generation entity P3 of the property information 131g as illustrated in FIG. 27. As illustrated in FIG. 27, for example, the property information 131i is property information 131 including a property including a sentence “Mr. F is in Y city.” in which the generation entity P3 is the “position information service H”.

Further, for example, in a case where the property information 131 acquired in the process of S41 or the like is property information 131h, the second information generation unit 116 acquires property information 131j, which is the property information 131 for the generation entity P3 of the property information 131h, as illustrated in FIG. 27. As illustrated in FIG. 27, for example, the property information 131j is property information 131 including a property including a sentence “Mr. G has a record of image analysis at I Laboratory.” in which the generation entity P3 is the “I laboratory”.

Then, for example, the second information generation unit 116 determines whether or not the information indicating the generation entity P3 of the property information 131 acquired in the process of S61 is included in the second list information 136 (S62).

As a result, for example, in a case where it is determined that the information indicating the generation entity P3 of the property information 131 acquired in the process of S61 is included in the second list information 136 (YES in S63), the second information generation unit 116 generates first reliability degree information CRa indicating that the reliability degree of the generation entity P3 of the property information 131 acquired in S41 is a third degree (S64).

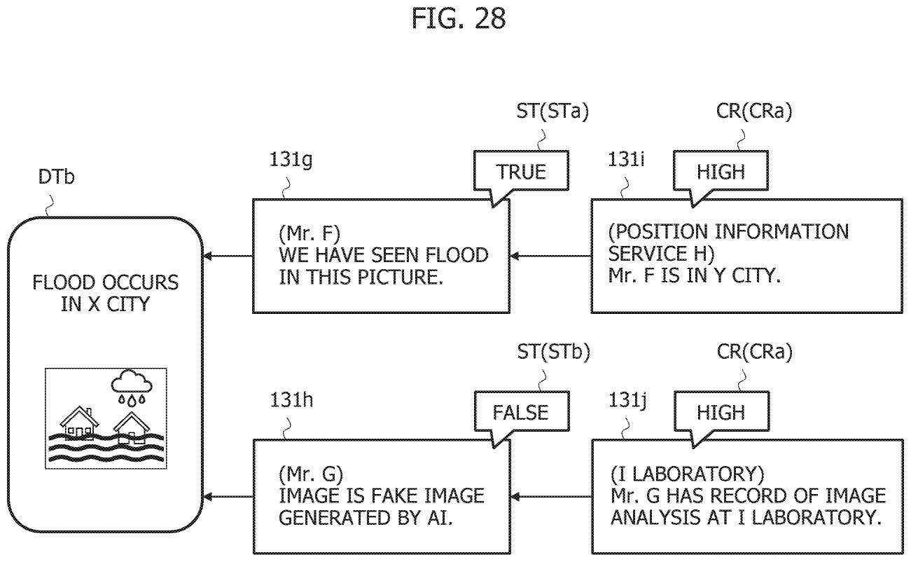

Specifically, the second list information 136 illustrated in FIG. 26 includes, for example, information indicating the position information service H that is the generation entity P3 of the property information 131i. Therefore, for example, in a case where the property information 131 acquired in the process of S61 is the property information 131i, the second information generation unit 116 generates “high” indicating the first reliability degree information CRa as the reliability degree information CR corresponding to the property information 131i as illustrated in FIG. 28. That is, in this case, for example, the second information generation unit 116 generates the first reliability degree information CRa indicating that the reliability degree of the generation entity P3 of the property information 131i is high as the reliability degree information CR corresponding to the property information 131i.

In addition, the second list information 136 illustrated in FIG. 26 includes, for example, information indicating the I laboratory that is the generation entity P3 of the property information 131j. Therefore, for example, in a case where the property information 131 acquired in the process of S61 is the property information 131j, the second information generation unit 116 generates “high” indicating the first reliability degree information CRa as the reliability degree information CR corresponding to the property information 131j as illustrated in FIG. 28. That is, in this case, for example, the second information generation unit 116 generates the first reliability degree information CRa indicating that the reliability degree of the generation entity P3 of the property information 131j is high as the reliability degree information CR corresponding to the property information 131j.

On the other hand, for example, in a case where it is determined that the information indicating the generation entity P3 of the property information 131 acquired in the process of S61 is not included in the second list information 136 (NO in S63), the second information generation unit 116 determines whether or not the number of executions of the process of S61 has reached a predetermined number (S65). The predetermined number may be, for example, one or more.

As a result, for example, in a case where it is determined that the number of executions of the process of S61 has not reached the predetermined number (NO of S65), the second information generation unit 116 executes the processes of S61 and subsequent steps again.

That is, in the recursion process, for example, until the property information 131 where the generation entity P3 is included in the second list information 136 is specified, in other words, until the property information 131 generated by the generation entity P3 that can be determined to have high reliability is specified, the second information generation unit 116 sequentially traces the property information 131 related to the post DT corresponding to the determination request information received in the process of S21. Then, for example, as a result of sequentially tracing the property information 131 related to the post DT corresponding to the determination request information received in the process of S21, in a case where the property information 131 in which the generation entity P3 is included in the second list information 136 is specified, the second information generation unit 116 determines that the reliability degree of the generation entity P3 of the property information 131 acquired in the process of S41 is high.

On the other hand, for example, in a case where it is determined that the number of executions of the process of S61 has reached the predetermined number (YES in S65), the second information generation unit 116 generates reliability degree information CR (hereinafter, also referred to as second reliability degree information CRb) indicating that the reliability degree of the generation entity P3 of the property information 131 acquired in the process of S41 is a fourth degree (S66). The fourth degree is, for example, a degree lower than the third degree. That is, the second reliability degree information CRb is, for example, information indicating that the reliability of the generation entity P3 of the property information 131 acquired in the process of S41 is lower than that of the first reliability degree information CRa.

That is, in the recursion process, for example, as a result of sequentially tracing the property information 131 related to the post DT corresponding to the determination request information received in the process of S21, in a case where the property information 131 in which the generation entity P3 is included in the second list information 136 is not specified, the second information generation unit 116 determines that the reliability degree of the generation entity P3 of the property information 131 acquired in the process of S41 is low.

Then, the second information generation unit 116 ends the recursion process, for example, after the process of S64 or the process of S66.

Returning to FIG. 19, after the process of S44 or the process of S45, the second information generation unit 116 determines, for example, whether or not the entire property information 131 determined to exist in the process of S24 has been acquired (S46).

As a result, in a case where it is determined that the entire property information 131 determined to exist in the process of S24 has not been acquired (NO of S46), the second information generation unit 116 performs the processes of S41 and subsequent steps again, for example.

On the other hand, in a case where it is determined that the entire property information 131 determined to exist in the process of S24 has been acquired (YES in S46), the second information generation unit 116 ends the process of S26, for example.

Returning to FIG. 17, for example, the information determination unit 117 determines the certainty of the post DT corresponding to the determination request information received in the process of S21, based on each piece of affirmation degree information ST generated in the process of S25 and each piece of reliability degree information CR generated in the process of S26 (S27). Hereinafter, details of the process of S27 will be described.

### Details of Process in S27

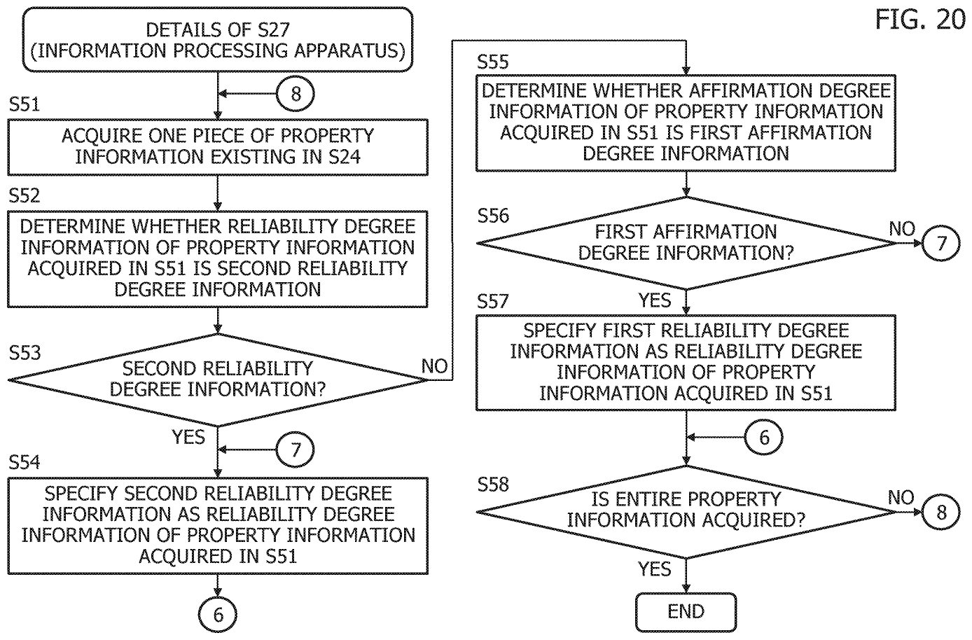

FIG. 20 is a flowchart illustrating details of the process of S27.

As illustrated in FIG. 20, the information determination unit 117 acquires, for example, one piece of property information 131 determined to exist in the process of S24 (S51).

Then, for example, the information determination unit 117 determines whether or not the reliability degree information CR of the property information 131 acquired in the process of S51 is the second reliability degree information CRb (S52).

As a result, for example, in a case where it is determined that the reliability degree information CR of the property information 131 acquired in the process of S51 is the second reliability degree information CRb (YES in S53), the information determination unit 117 specifies the second reliability degree information CRb as the reliability degree information CR of the property information 131 acquired in the process of S51 (S54).

That is, in this case, for example, the information determination unit 117 maintains the second reliability degree information CRb as the reliability degree information CR of the property information 131 acquired in the process of S51.

On the other hand, for example, in a case where it is determined that the reliability degree information CR of the property information 131 acquired in the process of S51 is not the second reliability degree information CRb (NO in S53), the information determination unit 117 determines whether or not the affirmation degree information ST of the property information 131 acquired in the process of S51 is the first affirmation degree information STa (S55).

Specifically, in this case, for example, the first information generation unit 115 generates affirmation degree information ST of the property information 131 acquired in the process of S51 (S31 to S35). Then, for example, the information determination unit 117 determines whether or not the affirmation degree information ST generated by the first information generation unit 115 is the first affirmation degree information STa.

As a result, for example, in a case where it is determined that the affirmation degree information ST of the property information 131 acquired in the process of S51 is not the first affirmation degree information STa (NO of S56), the information determination unit 117 performs the processes of S54 and subsequent steps.

That is, in this case, for example, the information determination unit 117 changes the reliability degree information CR of the property information 131 acquired in the process of S51 from the first reliability degree information CRa to the second reliability degree information CRb.

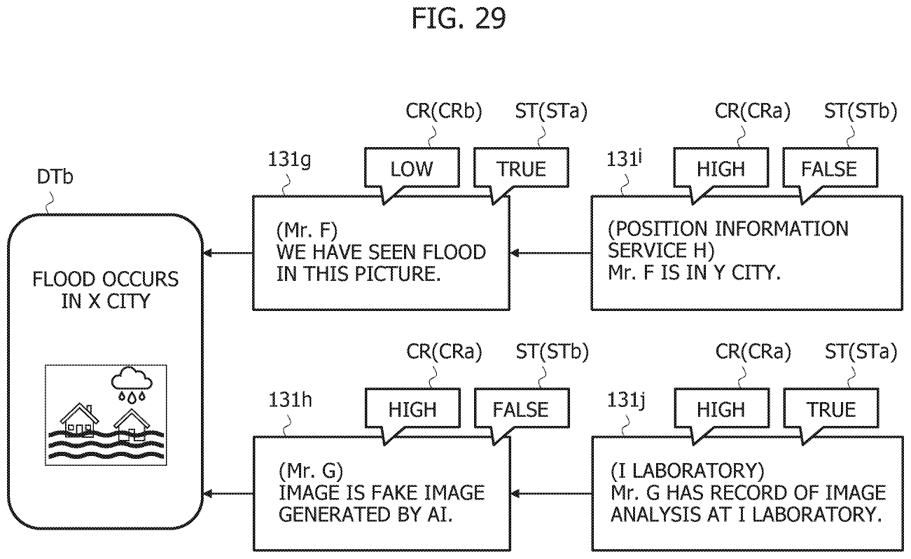

Specifically, as illustrated in FIG. 29, for example, in a case where the reliability degree information CR corresponding to the property information 131i is “high” indicating the first reliability degree information CRa, and the affirmation degree information ST corresponding to the property information 131i is “FALSE” indicating the second affirmation degree information STb (NO in S53 and NO in S56), the information determination unit 117 determines that there is high reliability that the content of the property information 131g (property information 131g for the post DT corresponding to the determination request information received in the process of S21) which is the property information 131 acquired in S51 is erroneous, and specifies “low” which is the second reliability degree information CRb as the reliability degree information CR corresponding to the property information 131g (S54).

On the other hand, for example, in a case where it is determined that the affirmation degree information ST of the property information 131 acquired in the process of S51 is the first affirmation degree information STa (YES in S56), the information determination unit 117 specifies the first reliability degree information CRa as the reliability degree information CR of the property information 131 acquired in the process of S51 (S57).

That is, in this case, for example, the information determination unit 117 maintains the first reliability degree information CRa as the reliability degree information CR of the property information 131 acquired in the process of S51.

Specifically, as illustrated in FIG. 29, for example, in a case where the reliability degree information CR corresponding to the property information 131j is “high” indicating the first reliability degree information CRa, and the affirmation degree information ST corresponding to the property information 131j is “TRUE” indicating the first affirmation degree information STa (NO in S53 and YES in S56), the information determination unit 117 determines that there is high reliability that the content of the property information 131h (property information 131h for the post DT corresponding to the determination request information received in the process of S21) which is the property information 131 acquired in S51 is correct, and specifies “high” which is the first reliability degree information CRa as the reliability degree information CR corresponding to the property information 131h (S57).

Then, for example, the information determination unit 117 determines whether or not the entire property information 131 determined to exist in the process of S24 has been acquired (S58).

As a result, in a case where it is determined that the entire property information 131 determined to exist in the process of S24 has not been acquired (NO of S58), the information determination unit 117 performs the processes of S51 and subsequent steps again, for example.

On the other hand, in a case where it is determined that the entire property information 131 determined to exist in the process of S24 has been acquired (YES in S58), the information determination unit 117 ends the process of S27, for example.

Returning to FIG. 17, for example, the information output unit 118 transmits, to the operation terminal 2, output information OP indicating a determination result (determination result in the process of S27) for the certainty of the post DT corresponding to the determination request information received in the process of S21 (S28).

Specifically, for example, the information output unit 118 transmits the output information OP to the operation terminal 2 that has transmitted the determination request information received in the process of S21.

Thereafter, the operation terminal 2 outputs (displays), for example, the output information OP transmitted by the information output unit 118 to the output device. That is, in this case, for example, the operation terminal 2 causes the output information OP transmitted by the information output unit 118 to be readable by the reader P2.

Specifically, the information output unit 118 transmits, for example, information indicating the property information 131 in which the first reliability degree information CRa is specified as the reliability degree information CR in the process of S27 among the property information 131 existing in the process of S24 to the operation terminal 2.

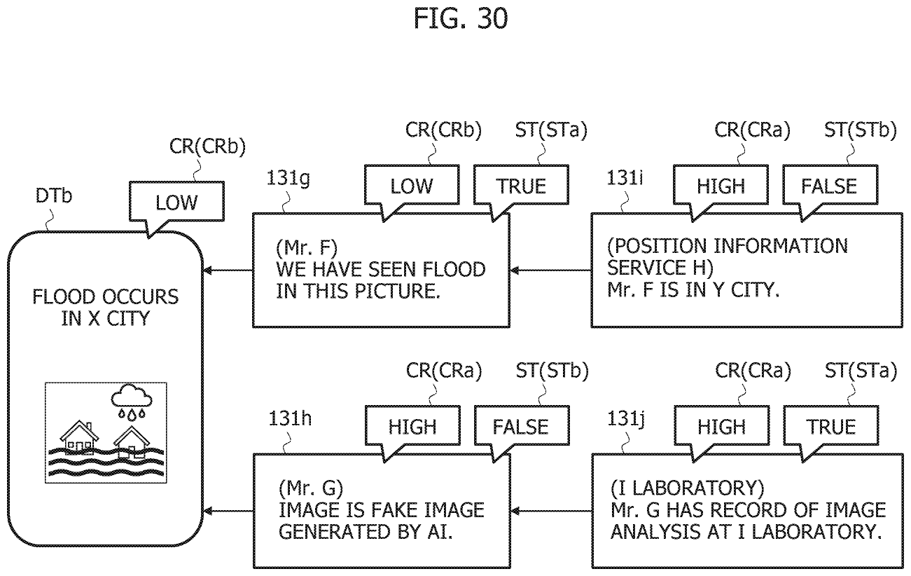

More specifically, as illustrated in FIG. 30, for example, in a case where the reliability degree information CR corresponding to the property information 131g is “low” indicating the second reliability degree information CRb, and the reliability degree information CR corresponding to the property information 131h is “high” indicating the first reliability degree information CRa, the information determination unit 117 specifies the property information 131h in which the reliability degree information CR is the first reliability degree information CRa in the property information 131g and the property information 131h which are the property information 131 of the post DTb. Then, as illustrated in FIG. 30, for example, in a case where the affirmation degree information ST corresponding to the property information 131h is “FALSE” indicating the second affirmation degree information STb, and the reliability degree information CR corresponding to the property information 131h is “high” indicating the first reliability degree information CRa, the information determination unit 117 determines that there is high reliability that the content of the post DTb is erroneous, and generates the output information OP indicating that the reliability degree information CR corresponding to the post DTb is the second reliability degree information CRb. Thereafter, the information output unit 118 transmits, for example, the output information OP generated by the information determination unit 117 to the operation terminal 2. Hereinafter, a specific example of the output information OP will be described.

### Specific Example of Output Information

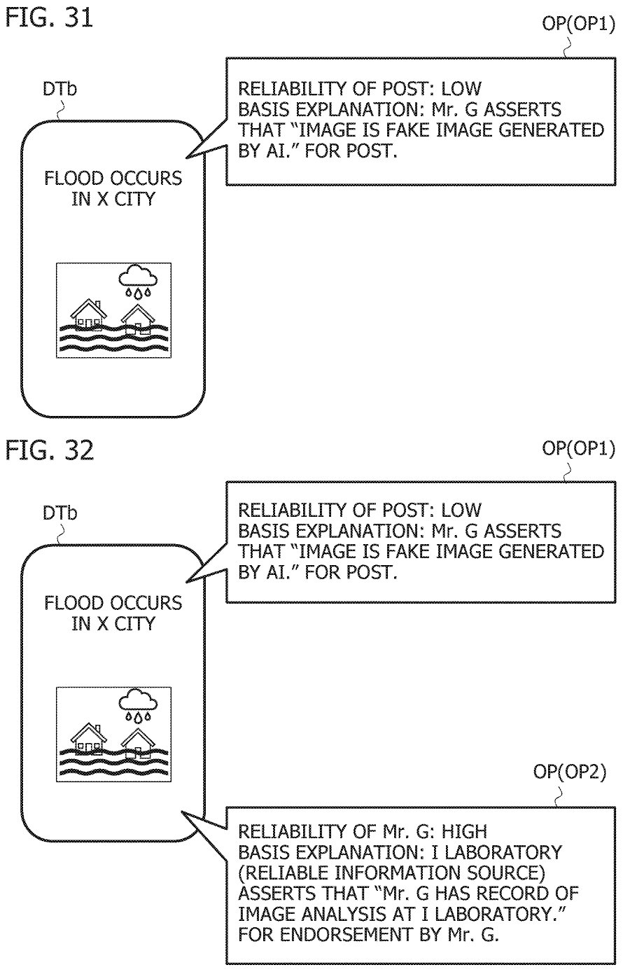

FIGS. 31 and 32 are diagrams illustrating a specific example of the output information OP. Specifically, FIGS. 31 and 32 are diagrams illustrating a specific example in a case where the output information OP is output (displayed) to the output device of the operation terminal 2.

As illustrated in FIG. 31, for example, the information output unit 118 transmits, to the operation terminal 2, output information OP (hereinafter, also referred to as output information OP1) including “reliability of post: low” indicating that the reliability degree information CR corresponding to the post DTb is the second reliability degree information CRb, and “basis explanation: Mr. G asserts that the image is a fake image generated by AI for the post” including the content of the property information 131h which is the property information 131 of the post DTb. Then, as illustrated in FIG. 31, the operation terminal 2 outputs (displays), for example, the output information OP1 transmitted by the information output unit 118 to the output device.

Note that, as illustrated in FIG. 32, for example, the information output unit 118 may further transmit, to the operation terminal 2, output information OP (hereinafter, also referred to as output information OP2) including “reliability of Mr. G: high” indicating that the reliability degree information CR corresponding to the property information 131j, which is the property information 131 of Mr. G who is the generation entity P3 of the property information 131h, is the first reliability degree information CRa and “basis explanation: I Laboratory (reliable information source) asserts that ‘Mr. G has a record of image analysis at I Laboratory’ for the endorsement by Mr. G” including the content of the property information 131j. Then, as illustrated in FIG. 32, the operation terminal 2 may output (display), for example, the output information OP2 transmitted by the information output unit 118 to the output device.

As described above, for example, in a case where the information processing apparatus 1 in the present embodiment receives determination request information for requesting determination on the certainty of the specific post DT, the information processing apparatus 1 refers to the storage device 4 that stores the correspondence information 132 and specifies the specific storage device 3 corresponding to the specific post DT from the plurality of storage devices 3. Then, for example, the information processing apparatus 1 refers to the specific storage device 3, and acquires the specific property information 131 indicating the certainty of the specific post DT from the specific storage device 3. Thereafter, for example, the information processing apparatus 1 generates the affirmation degree information ST indicating the affirmation degree of the content of the specific post DT for each piece of the acquired specific property information 131. Further, for example, the information processing apparatus 1 generates the reliability degree information CR indicating the reliability degree for the generation entity P3 for each piece of the acquired specific property information 131. Further, for example, the information processing apparatus 1 determines the certainty of the specific post DT based on the affirmation degree information ST and the reliability degree information CR for each piece of the acquired specific property information 131. Then, the information processing apparatus 1 outputs, for example, a determination result for the certainty of the specific post DT.

That is, for example, a plurality of pieces of property information 131 indicating views of different contents may be associated with the post DT uploaded onto the Internet IN. Then, in this case, for example, even in a case where the reader P2 refers to the property information 131 for the post DT, there is a possibility that the reader P2 is not able to determine the certainty of the post DT.

Therefore, for example, in a case where the information processing apparatus 1 in the present embodiment receives determination request information for the certainty of the specific post DT, the information processing apparatus 1 determines the certainty of the post DT by using the affirmation degree information ST corresponding to each piece of property information 131 and the reliability degree information CR corresponding to each piece of property information 131 in addition to the plurality of pieces of property information 131 associated with the post DT. Then, the information processing apparatus 1 outputs, for example, output information OP indicating a determination result for the certainty of the post DT.

As a result, for example, even in a case where a plurality of pieces of property information 131 indicating views of different contents is associated with the post DT, the reader P2 can determine the certainty of the post DT by reading the output information output from the information processing apparatus 1 together.

According to one aspect, it is possible to confirm the certainty of a post uploaded onto the Internet.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is;

1. An information processing apparatus comprising:
a processor; and
a memory coupled to the processor and the processor configured to:
when a determination request for the certainty of a specific post uploaded onto the Internet is received, acquire one or more pieces of property information indicating the certainty from a first storage;
generate, for each of the one or more pieces of acquired property information, first information indicating an affirmation degree of a content of the specific post by each piece of property information;
generate, for each of the one or more pieces of acquired property information, second information indicating a reliability degree of a generation entity of each piece of property information;
determine the certainty based on the first information and the second information for each of the one or more pieces of property information; and
output a determination result of the certainty.

2. The information processing apparatus according to claim 1,
wherein
the processor determines whether or not a specific word is included in each piece of property information for each of the one or more pieces of property information,
the processor
generates, as the first information corresponding to property information not including the specific word among the one or more pieces of property information, information indicating that an affirmation degree of the content of the specific post is a first degree, and
generates, as the first information corresponding to property information including the specific word among the one or more pieces of property information, information indicating that an affirmation degree of the content of the specific post is a second degree lower than the first degree.

3. The information processing apparatus according to claim 2,
wherein
the processor
determines, for each of the one or more pieces of property information, whether or not information indicating a generation entity of each piece of property information is stored in a second storage,
generates, as the second information corresponding to property information where information indicating the generation entity is stored in the second storage among the one or more pieces of property information, information indicating that a reliability degree of the generation entity is a third degree, and
generates, as the second information corresponding to property information where information indicating the generation entity is not stored in the second storage among the one or more pieces of property information, information indicating that a reliability degree of the generation entity is a fourth degree lower than the third degree.

4. The information processing apparatus according to claim 3,
wherein
the processor
specifies, from the one or more pieces of property information, specific property information corresponding to the second information where a reliability degree for the generation entity is the third degree, and
determines the certainty by using the first information corresponding to the specified specific property information.

5. The information processing apparatus according to claim 3,
wherein
the processor
acquires, from the first storage, other property information for a generation entity of property information where information indicating the generation entity is not stored in the second storage among the one or more pieces of property information, and
generates the second information for the acquired other property information as the second information for property information where information indicating the generation entity is not stored in the second storage.

6. A non-transitory computer-readable storage medium storing therein an information management program for causing a computer to execute a process comprising:
when a determination request for the certainty of a specific post uploaded onto the Internet is received, acquiring one or more pieces of property information indicating the certainty from a first storage;
generating, for each of the one or more pieces of acquired property information, first information indicating an affirmation degree of a content of the specific post by each piece of property information;
generating, for each of the one or more pieces of acquired property information, second information indicating a reliability degree of a generation entity of each piece of property information;
determining the certainty based on the first information and the second information for each of the one or more pieces of property information; and
outputting a determination result of the certainty.

7. The non-transitory computer-readable storage medium according to claim 6, wherein
the process of generating the first information
determines whether or not a specific word is included in each piece of property information for each of the one or more pieces of property information,
generates, as the first information corresponding to property information not including the specific word among the one or more pieces of property information, information indicating that an affirmation degree of the content of the specific post is a first degree, and
generates, as the first information corresponding to property information including the specific word among the one or more pieces of property information, information indicating that an affirmation degree of the content of the specific post is a second degree lower than the first degree.

8. The non-transitory computer-readable storage medium according to claim 7, wherein
the process of generating the second information
determines, for each of the one or more pieces of property information, whether or not information indicating a generation entity of each piece of property information is stored in a second storage,
generates, as the second information corresponding to property information where information indicating the generation entity is stored in the second storage among the one or more pieces of property information, information indicating that a reliability degree of the generation entity is a third degree, and
generates, as the second information corresponding to property information where information indicating the generation entity is not stored in the second storage among the one or more pieces of property information, information indicating that a reliability degree of the generation entity is a fourth degree lower than the third degree.

9. An information management method comprising:
causing a computer to execute a process including:
when a determination request for the certainty of a specific post uploaded onto the Internet is received, acquiring one or more pieces of property information indicating the certainty from a first storage;
generating, for each of the one or more pieces of acquired property information, first information indicating an affirmation degree of a content of the specific post by each piece of property information;
generating, for each of the one or more pieces of acquired property information, second information indicating a reliability degree of a generation entity of each piece of property information;
determining the certainty based on the first information and the second information for each of the one or more pieces of property information; and
outputting a determination result of the certainty.

10. The information management method according to claim 9,
wherein
the process of generating the first information
determines whether or not a specific word is included in each piece of property information for each of the one or more pieces of property information,
generates, as the first information corresponding to property information not including the specific word among the one or more pieces of property information, information indicating that an affirmation degree of the content of the specific post is a first degree, and
generates, as the first information corresponding to property information including the specific word among the one or more pieces of property information, information indicating that an affirmation degree of the content of the specific post is a second degree lower than the first degree.

11. The information management method according to claim 10,
wherein
the process of generating the second information
determines, for each of the one or more pieces of property information, whether or not information indicating a generation entity of each piece of property information is stored in a second storage,
generates, as the second information corresponding to property information where information indicating the generation entity is stored in the second storage among the one or more pieces of property information, information indicating that a reliability degree of the generation entity is a third degree, and
generates, as the second information corresponding to property information where information indicating the generation entity is not stored in the second storage among the one or more pieces of property information, information indicating that a reliability degree of the generation entity is a fourth degree lower than the third degree.
